(19) United States
(12) Patent Application Publication
(10) Pub. No.: US 2026/0184825 A1
(43) Pub. Date: Jul. 2, 2026

(54) HIGH-REFRACTIVE-INDEX TRANSPARENT CYCLIC OLEFIN POLYMER AND PREPARATION METHOD THEREOF

(71) Applicant: Tianjin University, Tianjin (CN)

(72) Inventors: Li Pan, Tianjin (CN); Weizhong Li, Tianjin (CN); Yuesheng Li, Tianjin (CN); Huan Gao, Tianjin (CN)

(21) Appl. No.: 19/421,881

(22) Filed: Dec. 16, 2025

(30) Foreign Application Priority Data
Jan. 2, 2025 (CN) 202510003474X
Jan. 2, 2025 (CN) 2025100028202

(51) Int. Cl. C08F 12/32; C08F 4/22; C08F 4/26

(52) U.S. Cl. CPC C08F 12/32; C08F 4/22; C08F 4/26; C08F 2500/25

(57) ABSTRACT

The present invention relates to the technical field of novel high-end polyolefins, in particular to a high-refractive-index, transparent cyclic olefin polymer and a preparation method thereof. The cyclic olefin polymer has a structure represented by formula (I):

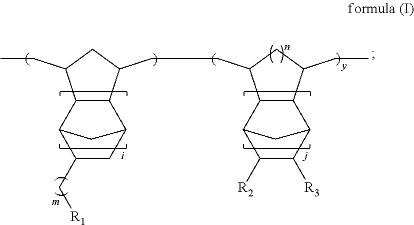

The cyclic olefin polymer of the present invention has a refractive index of 1.62-1.70, an Abbe number of 14-25, a light transmittance greater than 90%, and a water absorption of less than 0.01%, and exhibits a glass transition temperature of 130-185° C. In addition, by using commercial catalysts, a monomer conversion of more than 99% can be achieved without crosslinking or other side reactions.

### TECHNICAL FIELD

The present invention relates to the technical field of novel high-end polyolefins, and in particular to a high-refractive-index, transparent cyclic olefin polymer and a preparation method thereof.

### BACKGROUND

Cyclic olefin polymers are novel polymers that have attracted much attention in the field of high-performance polymer materials in recent years. They are mainly formed by copolymerization of cycloolefin monomers with other monomers through specific copolymerization reactions. Due to their unique molecular structures and excellent physicochemical properties, they have been widely used in electronics, optics, medical devices, packaging and other fields. Cyclic olefin polymers exhibit outstanding optical performance, good heat resistance, low water absorption and excellent dimensional stability, which makes them show significant advantages in many applications where traditional materials cannot meet the requirements.

Refractive index, as an important parameter determining the performance of these materials in optical applications, has received extensive attention. Commercial cyclic olefin polymers have a refractive index of about 1.53 to 1.55 and exhibit low birefringence and high transparency, enabling excellent optical transparency and imaging quality in optical lenses, MR/AR and optical panels. However, with the continuous improvement of requirements in the optical field, the refractive index of existing materials has become insufficient to meet the needs of new applications, and there is an increasing demand for materials that have higher refractive index while simultaneously possessing transparency, heat resistance, and low water absorption.

Therefore, how to further improve the refractive index of cyclic olefin polymers while also balancing transparency, heat resistance, and low water absorption has become a major challenge and difficulty in current research.

### SUMMARY

In order to solve the above problems, the present invention provides a high-refractive-index, transparent cyclic olefin polymer and a preparation method thereof. The cyclic olefin polymer provided by the present invention exhibits a high refractive index while also achieving high transparency, high heat resistance, and low water absorption.

To achieve the above objects, the present invention provides the following technical solutions. According to a first aspect of the technical solution of the present invention, there is provided a cyclic olefin polymer having a structure represented by formula (I):

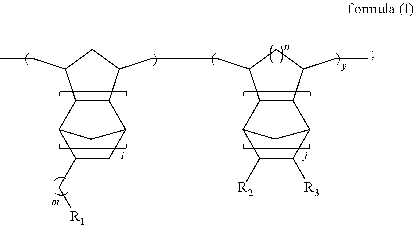

in formula (I), x and y are degrees of polymerization, 10≤x≤850, 0≤y≤750, but this does not indicate a block copolymer; the dashed line represents a bond or no bond; i and j are ring numbers, i is 0 or 1, j is 0 or 1; m and n are carbon atom numbers, 0≤m≤10, 0≤n≤4;
in formula (I), R₁ is selected from one of S1-S10:

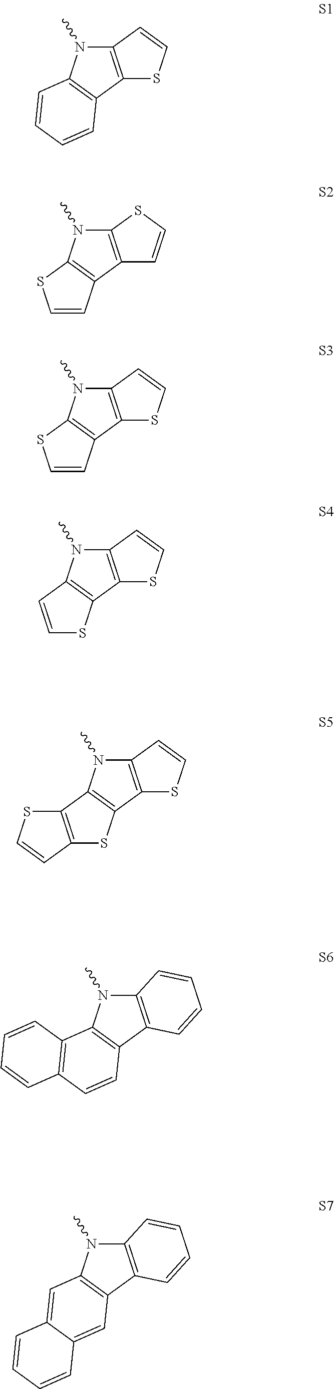

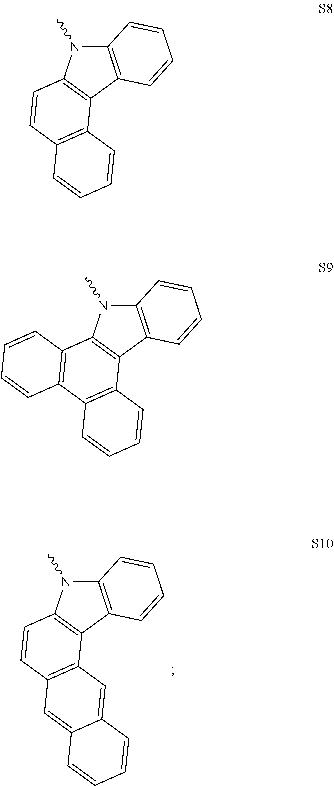

in formula (I), R₂ and R₃ are each independently selected from hydrogen, alkyl and alkenyl, and a bond may or may not be formed between R₂ and R₃.

According to a second aspect of the technical solution of the present invention, there is provided a preparation method of the cyclic olefin polymer, comprising the steps of:
in the presence of a catalyst, carrying out a ring-opening metathesis polymerization reaction of monomers under a protective atmosphere to obtain a polymerization reaction product;
subjecting the polymerization reaction product to a hydrogenation reaction to obtain the cyclic olefin polymer;
wherein the monomers comprise at least one compound of formula (II) and at least one compound of formula (III);
the compound of formula (II) has the structure:

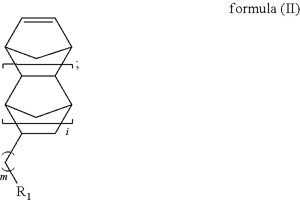

in formula (II), i is a ring number, i is 0 or 1; m is a carbon atom number, 0≤m≤10;
in formula (II), R₁ is the same as R₁ described above and is selected from one of S1-S10:

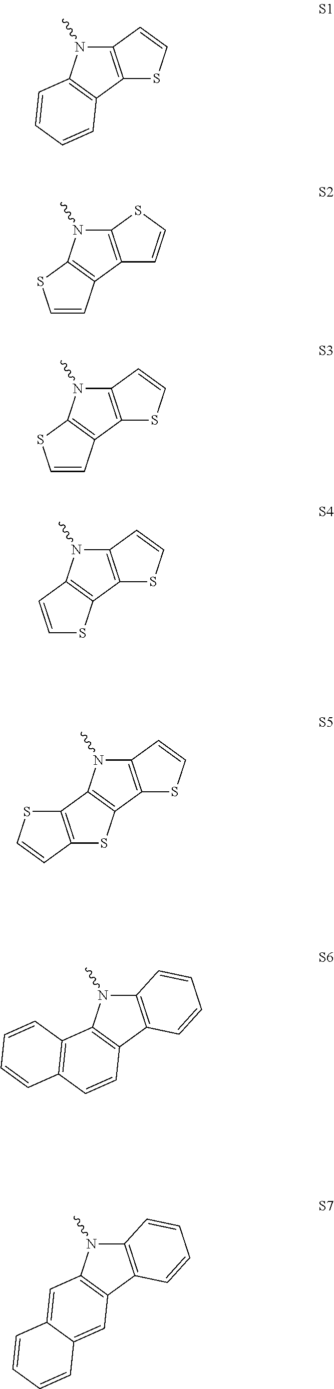

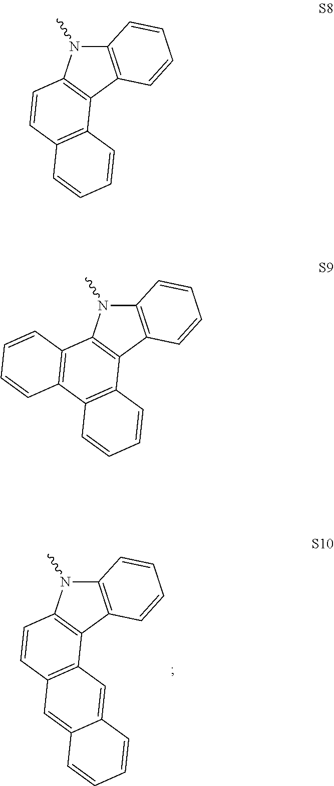

The compound of formula (III) has the structure:

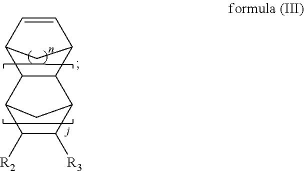

in formula (III), the dashed line represents a bond or no bond; j is a ring number, j is 0 or 1; n is a carbon atom number, 0≤n≤4; R₂ and R₃ are each independently selected from hydrogen, alkyl, and alkenyl, and a bond may or may not be formed between R₂ and R₃.

In a preferred embodiment of the present invention, the compound of formula (II) is selected from at least one of HM1-HM18:

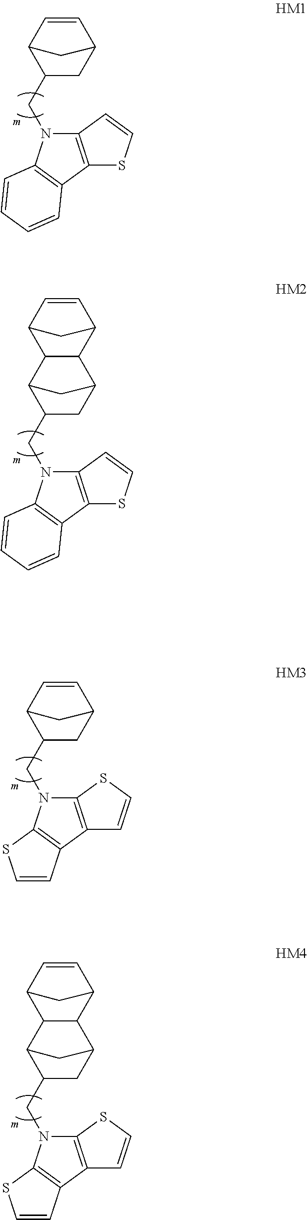

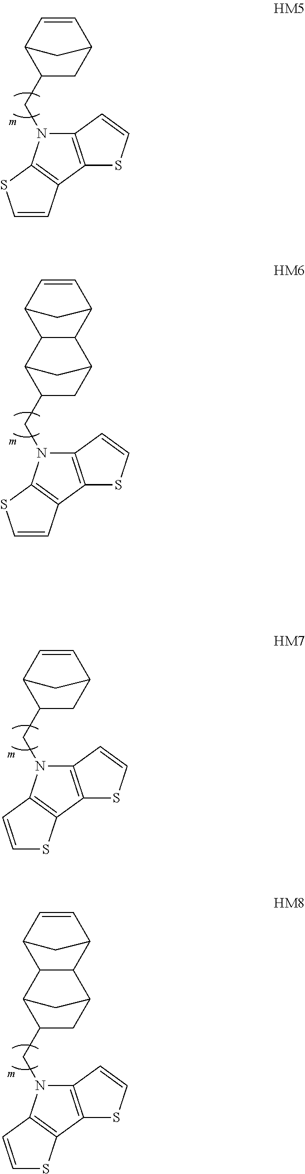

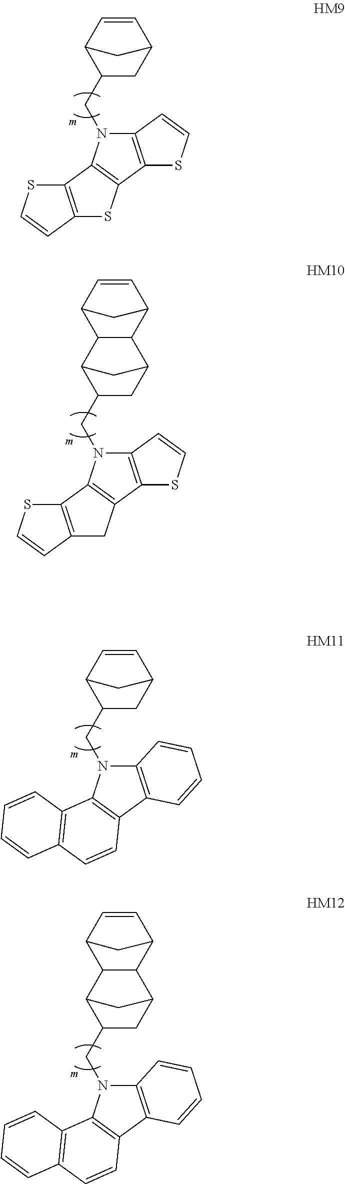

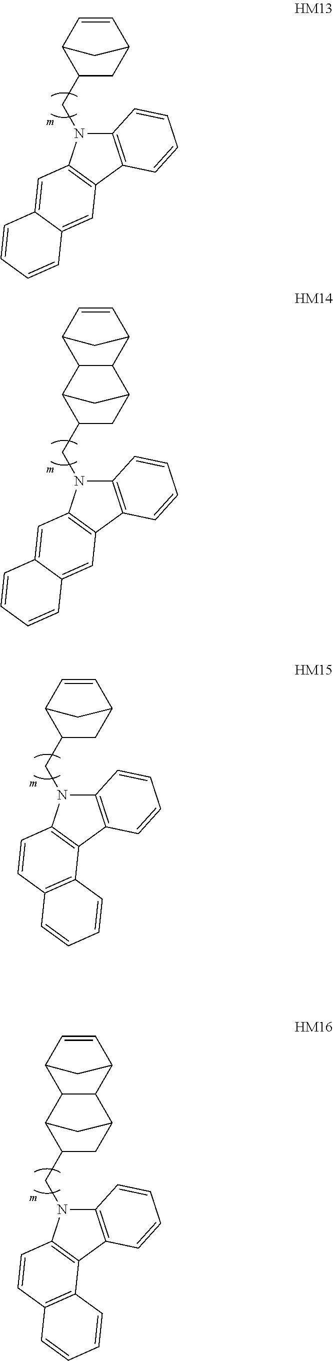

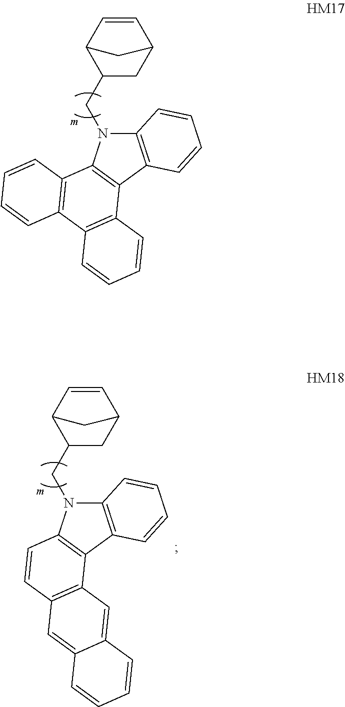

wherein m is a carbon atom number, 0≤m≤10.

In a preferred embodiment of the present invention, the compound of formula (III) is selected from at least one of M1-M10:

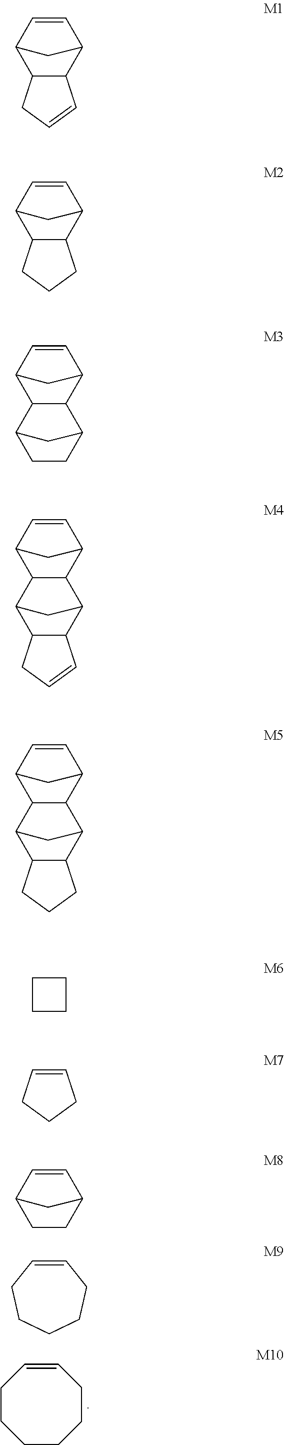

The source of the cycloolefin monomers having the structures shown in formula (II) and formula (III) is not particularly limited in the present invention, and they can be obtained by using preparation techniques well known to those skilled in the art.

In the present invention, the compound of formula (II) can yield a cycloolefin polymer after ring-opening metathesis followed by hydrogenation. The polymer can be repeatedly dissolved and processed, and is colorless and transparent.

In the present invention, the cycloolefin monomer is dissolved in a solvent and then subjected to subsequent ring-opening metathesis polymerization. The solvent is a hydrocarbon compound, a halogenated hydrocarbon compound, a cycloalkane compound or an aromatic hydrocarbon compound; preferably cyclopentane, hexane, cyclohexane, decane, isododecane, benzene, toluene, xylene, ethylbenzene, chlorobenzene, dichloromethane or chloroform; more preferably benzene, toluene, xylene, chlorobenzene, dichloromethane, chloroform or cyclohexane. The source of the solvent is not particularly limited in the present invention, and the above-mentioned types of solvents well known to those skilled in the art can be used and can be purchased on the market. The amount of the solvent is not particularly limited in the present invention, and the amount commonly used for solvents in polymerization reactions, as known to those skilled in the art, can be used. The manner of dissolution is not particularly limited in the present invention, and for example, stirring dissolution can be adopted, and the stirring method can be selected from the stirring techniques well known to those skilled in the art. In the present invention, the stirring time is preferably 4-10 min, more preferably 4-8 min, and most preferably 5 min.

In a preferred embodiment of the present invention, the catalyst is a ruthenium catalyst, a molybdenum catalyst, or a tungsten catalyst, preferably a ruthenium catalyst.

In the present invention, the ruthenium catalyst is preferably one of the structures of formula (IV):

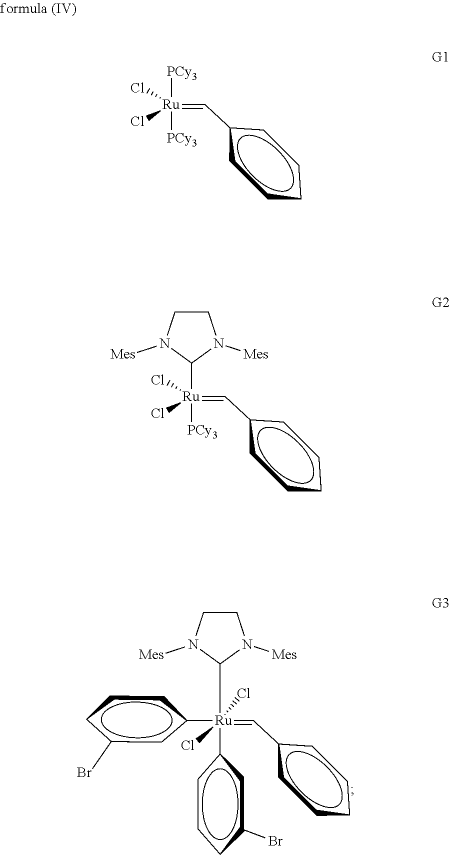

in formula (IV), PCy₃ is tricyclohexylphosphine, and Mes is 2,4,6-trimethylphenyl.

The catalyst used in the present invention has the advantages of high activity and good tolerance to polymerization, and in the process of preparing the cyclic olefin polymer of the present invention, it has the advantages that no cocatalyst is required, the initiation rate is fast, the catalytic conversion rate reaches 100%, and no crosslinking or other side reactions occur. The source of the catalyst of formula (IV) used in the present invention is not particularly limited and it can be purchased from the market.

In the present invention, the ruthenium catalyst is dissolved in a solvent and then used to catalyze the ring-opening metathesis polymerization of monomer compounds; the solvent is the same as the solvent mentioned above (used to dissolve the cycloolefin monomers), specifically being a hydrocarbon compound, a halogenated hydrocarbon compound, a cycloalkane compound or an aromatic hydrocarbon compound; preferably cyclopentane, hexane, cyclohexane, decane, isododecane, benzene, toluene, xylene, ethylbenzene, chlorobenzene, dichloromethane or chloroform; more preferably benzene, toluene, xylene, chlorobenzene, dichloromethane, chloroform or cyclohexane. The source of the solvent is not particularly limited, and the above-mentioned types of solvents well known to those skilled in the art can be used and can be purchased on the market.

In a preferred embodiment of the present invention, the molar ratio of the monomer to the catalyst is (100-1600): 1, preferably (200-1000): 1, and more preferably (200-800):1.

In a preferred embodiment of the present invention, the temperature of the ring-opening metathesis polymerization reaction is 25-80° C., preferably 25-60° C., more preferably 25-40° C.; the reaction time of the ring-opening metathesis polymerization is 4-240 min, preferably 30-150 min, more preferably 60-120 min.

The ring-opening metathesis polymerization is preferably carried out under anhydrous and oxygen-free conditions in the present invention. In the present invention, a standard Schlenk flask is used and the reaction is conducted under a nitrogen atmosphere. The ring-opening metathesis polymerization reaction is preferably carried out under stirring in the present invention, and the stirring method of the polymerization reaction is not particularly limited and can be selected from the stirring techniques well known to those skilled in the art.

In the present invention, after completion of the ring-opening metathesis polymerization reaction, a step of terminating the ring-opening metathesis polymerization reaction and separating the reaction product is further included; termination of the ring-opening metathesis polymerization reaction is preferably performed by adding a terminator; the separation specifically comprises: mixing the polymerization reaction solution with a precipitant to obtain a precipitated product, then filtering, washing, and drying the precipitated product to obtain the polymerization reaction product.

The type and source of the terminator are not particularly limited in the present invention and can be selected from those well known to those skilled in the art. For the preparation of cyclic olefin polymers, terminators can be purchased from the market. In the present invention, the terminator is preferably ethyl vinyl ether. The molar ratio of the terminator to the catalyst is preferably (100-800): 1, more preferably (200-400): 1, and most preferably 300:1; the termination time of the polymerization reaction is preferably 20-60 min, more preferably 30-35 min.

The methods of filtering, washing and drying the precipitated product are not particularly limited in the present invention and can be selected from the techniques well known to those skilled in the art. Ethanol is preferably used as the washing solvent, and the number of washing operations is preferably 1-5 times, more preferably 3 times. The drying method is preferably vacuum drying, the drying temperature is preferably 20-60° C., more preferably 30-50° C., and most preferably 40° C. The drying time is preferably 12-24 h, more preferably 14-20 h, and most preferably 16 h.

In the present invention, after the polymerization reaction product is obtained, the polymerization reaction product and a hydrogen source are subjected to a hydrogenation reaction to obtain a cyclic olefin polymer. The hydrogenation reaction is preferably carried out under a protective gas atmosphere in the present invention. In the present invention, the protective gas for the hydrogenation reaction is preferably nitrogen. The method of the hydrogenation reaction is not particularly limited in the present invention and can be selected from hydrogenation techniques well known to those skilled in the art.

The type of the hydrogen source is not particularly limited in the present invention, and the hydrogen source is preferably a hydrazine compound or hydrogen gas.

In the present invention, when the hydrogen source is a hydrazine compound, the hydrogenation reaction to prepare the cyclic olefin polymer is preferably carried out according to the following method: the polymerization reaction product and the hydrazine compound are subjected to a hydrogenation reaction in a solvent to obtain the cyclic olefin polymer. In the present invention, the hydrazine compound is preferably p-toluenesulfonyl hydrazide. The molar ratio of the moles of double bonds in the polymerization reaction product to the moles of the hydrazine compound is 1:(3-7), preferably 1:(5-6). The solvent is a hydrocarbon compound, a halogenated hydrocarbon compound, a cycloalkane compound or an aromatic hydrocarbon compound; preferably cyclopentane, hexane, cyclohexane, decane, isododecane, benzene, toluene, xylene, ethylbenzene, chlorobenzene, dichloromethane or chloroform; more preferably benzene, toluene, xylene, chlorobenzene, dichloromethane or chloroform; and most preferably toluene, xylene, or chlorobenzene. The amount of the solvent is not particularly limited in the present invention as long as a liquid environment for the hydrogenation reaction can be provided. The auxiliary agent used in the hydrogenation reaction is an amine compound, preferably tripropylamine. The reaction system further comprises a radical trapping agent. The kind and source of the radical trapping agent are not particularly limited in the present invention, and any common radical trapping agents on the market can be used. In the present invention, the radical trapping agent is preferably 2,6-di-tert-butyl-4-methylphenol, and the amount thereof may be 0.05-3 equiv relative to the moles of the catalyst. The temperature of the hydrogenation reaction is 100-150° C., preferably 110-130° C., and more preferably 120° C.; the reaction time is 12-24 h, preferably 14-18 h. After completion of the hydrogenation reaction, the hydrogenation reaction product is preferably mixed with ethanol in the present invention, and then subjected to filtration, washing and drying to obtain a hydrogenated cyclic olefin polymer. The purity of ethanol is preferably 95-99%; the drying method is preferably vacuum drying, the drying time is preferably 12-24 h, more preferably 16-20 h; the drying temperature is preferably 50-70° C., more preferably 55-65° C., and most preferably 60° C.

In the present invention, when the hydrogen source is hydrogen gas, the hydrogenation reaction to prepare the cyclic olefin polymer is preferably carried out according to the following method: the polymerization reaction product, hydrogen gas, and a catalyst are subjected to a hydrogenation reaction in a solvent to obtain the cyclic olefin polymer. In the present invention, the catalyst is a platinum catalyst, a palladium catalyst, a rhodium catalyst, or a nickel catalyst, preferably a palladium catalyst or a nickel catalyst. The solvent is a hydrocarbon compound, a halogenated hydrocarbon compound, a cycloalkane compound or an aromatic hydrocarbon compound; preferably cyclopentane, hexane, cyclohexane, decane, isododecane, benzene, toluene, xylene, ethylbenzene, chlorobenzene, dichloromethane or chloroform; more preferably benzene, toluene, xylene, chlorobenzene, dichloromethane or chloroform; and most preferably toluene, xylene or chlorobenzene. The amount of the solvent is not particularly limited in the present invention as long as a liquid environment for the hydrogenation reaction can be provided. The temperature of the hydrogenation reaction is 60-150° C., preferably 110-130° C., and more preferably 120° C.; the reaction time is 10-20 h, preferably 12-15 h. After completion of the hydrogenation reaction, the hydrogenation reaction product is preferably mixed with ethanol in the present invention and then subjected to filtration, washing and drying to obtain the hydrogenated cyclic olefin polymer. The purity of ethanol is preferably 95-99%; the drying method is preferably vacuum drying, the drying time is preferably 12-24 h, more preferably 16-20 h; the drying temperature is preferably 50-70° C., more preferably 55-65° C., and most preferably 60° C.

According to a third aspect of the technical solution of the present invention, there is provided an optical material, the raw material of which comprises the above-described cyclic olefin polymer.

The present invention discloses the following technical effects:
The present invention provides a cyclic olefin polymer having excellent properties, which has the characteristics of high refractive index, high transparency, high heat resistance and low water absorption. In addition, the cyclic olefin polymer of the present invention also has tunability in terms of refractive index, Abbe number and heat resistance. Experimental results show that, through the selection of specific molecular structures, the cyclic olefin polymer prepared in the present invention has a refractive index of 1.62-1.70 and an Abbe number of 14-25, with a light transmittance of more than 90% while maintaining low water absorption. The glass transition temperature of the material is 130-185° C., exhibiting excellent thermal stability. In addition, by using commercial catalysts, a monomer conversion of more than 99% can be achieved without crosslinking or other side reactions. These excellent properties indicate that the material has broad application prospects in the optical field.

### BRIEF DESCRIPTION OF DRAWINGS

In order to more clearly illustrate the technical solutions of the embodiments of the present invention or the prior art, the drawings to be used in the embodiments or the prior art will be briefly described below. Obviously, the drawings described below are only some embodiments of the present invention, and other drawings can be obtained by those skilled in the art without creative efforts on the basis of these drawings.

FIG. 1 is the 1H-NMR spectrum of the cycloolefin monomer obtained in Embodiment 1 of the present invention.

FIG. 2 is the 13C-NMR spectrum of the cycloolefin monomer obtained in Embodiment 1 of the present invention.

FIG. 3 is the 1H-NMR spectrum of the cycloolefin monomer obtained in Embodiment 6 of the present invention.

FIG. 4 is the 13C-NMR spectrum of the cycloolefin monomer obtained in Embodiment 6 of the present invention.

FIG. 5 is the 1H-NMR spectrum of the cyclic olefin polymer obtained in Embodiment 16 of the present invention.

FIG. 6 is the 13C-NMR spectrum of the cyclic olefin polymer obtained in Embodiment 16 of the present invention.

FIG. 7 is the 1H-NMR spectrum of the cyclic olefin polymer obtained in Embodiment 24 of the present invention.

FIG. 8 is the 13C-NMR spectrum of the cyclic olefin polymer obtained in Embodiment 24 of the present invention.

FIG. 9 is the refractive-index dispersion curve of the cyclic olefin polymer obtained in Embodiment 16 of the present invention.

FIG. 10 is the refractive-index dispersion curve of the cyclic olefin polymer obtained in Embodiment 25 of the present invention.

FIG. 11 is the differential scanning calorimetry (DSC) curve of the cyclic olefin polymer obtained in Embodiment 18 of the present invention.

FIG. 12 is the differential scanning calorimetry (DSC) curve of the cyclic olefin polymer obtained in Embodiment 24 of the present invention.

FIG. 13 is the transmittance curve of the cyclic olefin polymer obtained in Embodiment 20 of the present invention.

FIG. 14 is the transmittance curve of the cyclic olefin polymer obtained in Embodiment 31 of the present invention.

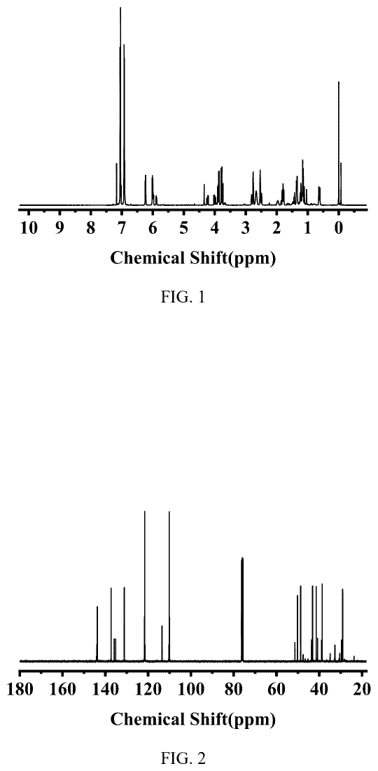

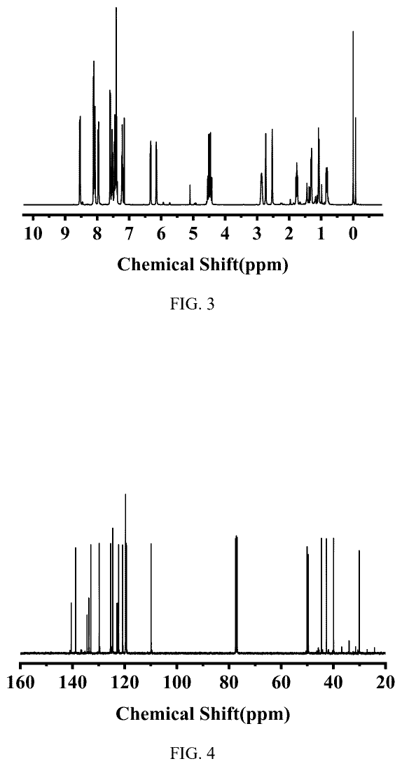

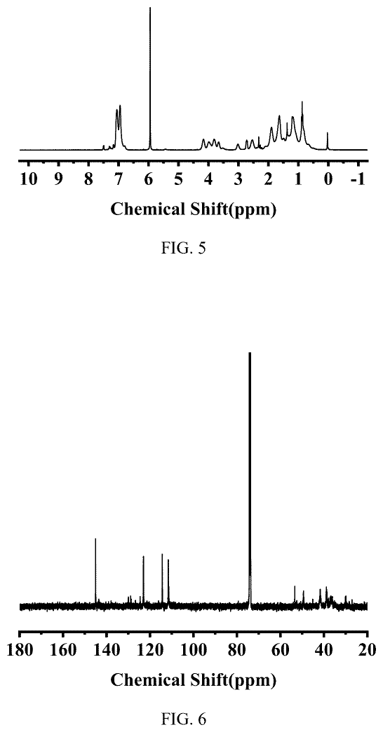

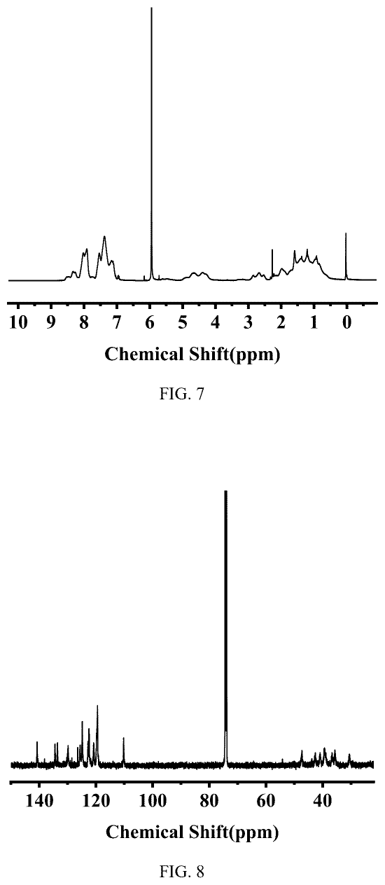

### DETAILED DESCRIPTION OF EMBODIMENTS

Various exemplary embodiments of the present invention will now be described in detail. This detailed description should not be construed as limiting the invention but rather as a more detailed description of certain aspects, features and implementations of the invention.

It should be understood that the terms used in the present invention are only for the purpose of describing particular embodiments and are not intended to limit the present invention. In addition, for numerical ranges in the present invention, it should be understood that every intermediate value between the upper and lower limits of the range is also specifically disclosed. Any intermediate value or any smaller range between any stated value or intermediate value and any other stated value or intermediate value within the range is also encompassed by the present invention. The upper and lower limits of these smaller ranges can be included in or excluded from the range.

Unless otherwise specified, all technical and scientific terms used herein have the same meanings as would be commonly understood by a person of ordinary skill in the art to which the present invention pertains. While the present invention has been described with reference to preferred methods and materials, any methods and materials similar or equivalent to those described herein may also be used in the practice or testing of the present invention. All publications mentioned in the present specification are incorporated herein by reference to disclose and describe the methods and/or materials related to the publications. In the event of any conflict between the incorporated publications and the present specification, the content of the present specification shall prevail.

Various modifications and variations can be made to the specific embodiments described in the present specification without departing from the scope or spirit of the invention, and such modifications and variations will be apparent to those skilled in the art. Other embodiments obtained from the description of the present invention will also be apparent to those skilled in the art. The specification and examples are merely exemplary.

As used herein, the terms “comprising”, “including”, “having”, “containing” and the like are all open-ended terms, meaning including but not limited to.

The cyclic olefin polymer prepared according to the present invention is measured as follows:

Conversion: In the present invention, the polymerization conversion of the polymerization reaction is determined by the method of weighing the product.

Nuclear Magnetic Resonance (NMR) Characterization: In the present invention, a Bruker 400 MHz nuclear magnetic resonance spectrometer is used. Deuterated chloroform (CDCl₃) or deuterated tetrachloroethane (C₂D₂Cl₄) is used as the solvent, and tetramethylsilane (TMS) is used as the internal standard.

Glass Transition Temperature (T_{g}): In the present invention, the glass transition temperature of the cyclic olefin polymer is obtained by differential thermal analysis, and the test method is DSC using a DSC Q200-TA differential scanning calorimeter, with heating and cooling rates of 10° C./min, and the second heating scan is used.

Refractive Index: In the present invention, an SE-VE-L ellipsometer is used to measure the refractive index in the wavelength range of 400-1000 nm, and the refractive index at 589 nm is selected.

Abbe Number: The Abbe number is calculated from the refractive indices at three wavelengths. In the present invention, the Abbe number is defined by the following formula:

$${v}_{d} = ( {n}_{d} - 1 ) / ( {n}_{F} - {n}_{C} ) ,$$

where nd, nF and nC represent the refractive indices at wavelengths of 589 nm, 486 nm and 656 nm, respectively.

Transparency: In the present invention, a Shimadzu UV-3600i UV-visible spectrophotometer is used to test the transparency of the cyclic olefin polymer, and the test wavelength is 400-800 nm.

Water Absorption: The method is as follows: after preparing samples with a thickness of 1-3 mm, they are immersed in water at 23° C. for 24 h according to ASTM-D 570, and the water absorption is calculated by measuring the mass change of the samples.

Unless otherwise specified, the technical solutions described in the present invention are conventional solutions in the art. Reagents or raw materials used, unless otherwise specified, can be prepared by methods known to those skilled in the art or purchased from the market.

The technical solutions provided by the present invention will be described in detail below with reference to the embodiments, but they should not be construed as limiting the scope of the present invention.

### Embodiment 1

### Synthesis of Cycloolefin Monomer HM7 (Side-Chain Carbon Number=1)

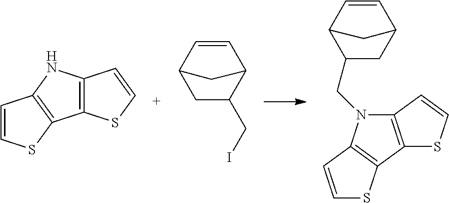 [SMILES: c1cc2[nH]c3ccsc3c2s1 ; ICC1CC2C=CC1C2 ; C1=CC2CC1CC2Cn1c2ccsc2c2sccc21]

Under a nitrogen atmosphere, 4H-dithieno[3,2-b: 2′, 3′-d]pyrrole (63 g, 0.35 mol) and sodium hydride (15 g, 0.62 mol) were mixed and stirred in anhydrous DMF for 2 h, followed by dropwise addition of 5-(iodomethyl) bicyclo[2.2.1]hept-2-ene (122 g, 0.52 mol), and the reaction was carried out at 120° C. for 24 h. The reaction mixture was extracted with ethyl acetate, rotary-evaporated to dryness, and purified by column chromatography with gradient elution (V (ethyl acetate): V (petroleum ether)=0-1:10). The product was dried under vacuum at 60° C. for 10 h to give a white solid (67 g, yield 67%).

### Embodiment 2

### Synthesis of Cycloolefin Monomer HM7 (Side-Chain Carbon Number=4)

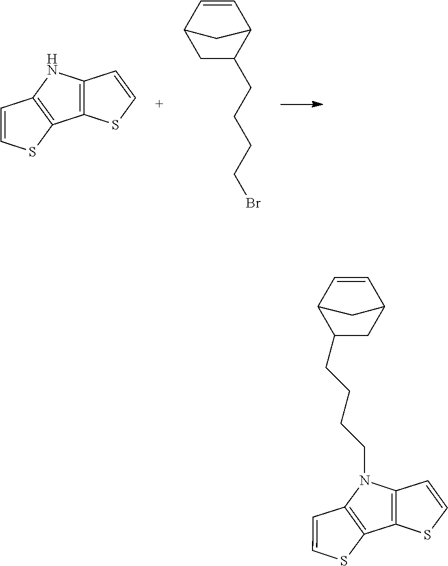 [SMILES: c1cc2[nH]c3ccsc3c2s1 ; BrCCCCC1CC2C=CC1C2 ; C1=CC2CC1CC2CCCCn1c2ccsc2c2sccc21]

Under a nitrogen atmosphere, 4H-dithieno[3,2-b: 2′, 3′-d]pyrrole (63 g, 0.35 mol) and sodium hydride (15 g, 0.62 mol) were mixed and stirred in anhydrous DMF for 2 h, followed by dropwise addition of 5-(4-bromobutyl) bicyclo[2.2.1]hept-2-ene (119 g, 0.52 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:20). The product was dried under vacuum at 60° C. for 10 h to give a white solid (92 g, yield 80%).

### Embodiment 3

### Synthesis of Cycloolefin Monomer HM8 (Side-Chain Carbon Number=1)

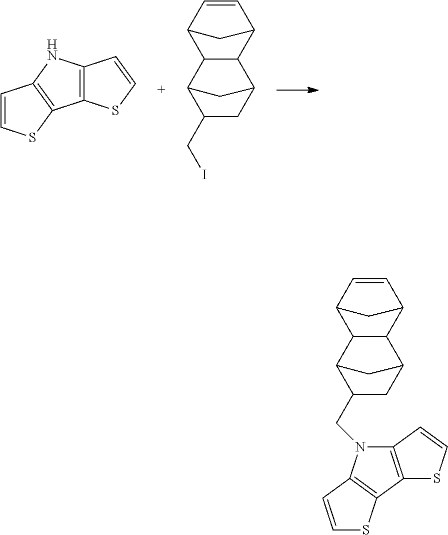 [SMILES: c1cc2[nH]c3ccsc3c2s1 ; ICC1CC2CC1C1C3C=CC(C3)C21 ; C1=CC2CC1C1C3CC(Cn4c5ccsc5c5sccc54)C(C3)C21]

Under a nitrogen atmosphere, 4H-dithieno[3,2-b: 2′, 3′-d]pyrrole (63 g, 0.35 mol) and sodium hydride (15 g, 0.62 mol) were mixed and stirred in anhydrous DMF for 2 h, followed by dropwise addition of 2-(iodomethyl)-1,2,3,4,4a,5,8,8a-octahydro-1,4:5,8-dimethanonaphthalene (156 g, 0.52 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:10). The product was dried under vacuum at 60° C. for 10 h to give a white solid (86 g, yield 70%).

### Embodiment 4

### Synthesis of Cycloolefin Monomer HM4 (Side-Chain Carbon Number=2)

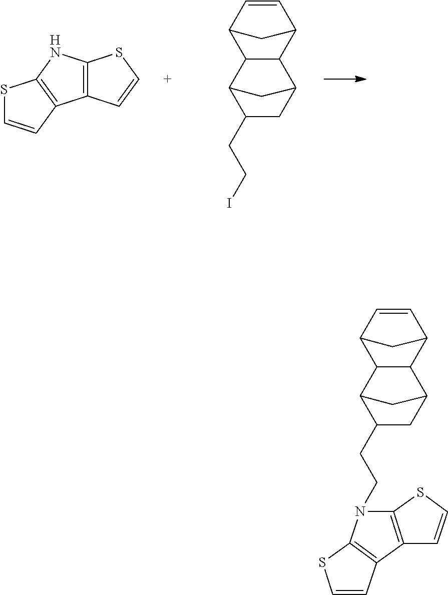 [SMILES: c1cc2c([nH]c3sccc32)s1 ; ICCC1CC2CC1C1C3C=CC(C3)C21 ; C1=CC2CC1C1C3CC(CCn4c5sccc5c5ccsc54)C(C3)C21]

Under a nitrogen atmosphere, 7H-dithieno[2,3-b: 3′,2′-d]pyrrole (63 g, 0.35 mol) and sodium hydride (15 g, 0.62 mol) were mixed and stirred in anhydrous DMF for 2 h, followed by dropwise addition of 2-(2-iodoethyl)-1,2,3,4,4a,5,8,8a-octahydro-1,4:5,8-dimethanonaphthalene (163 g, 0.52 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:10). The product was dried under vacuum at 60° C. for 10 h to give a white solid (91 g, yield 72%).

### Embodiment 5

### Synthesis of cycloolefin monomer HM3 (side-chain carbon number=6)

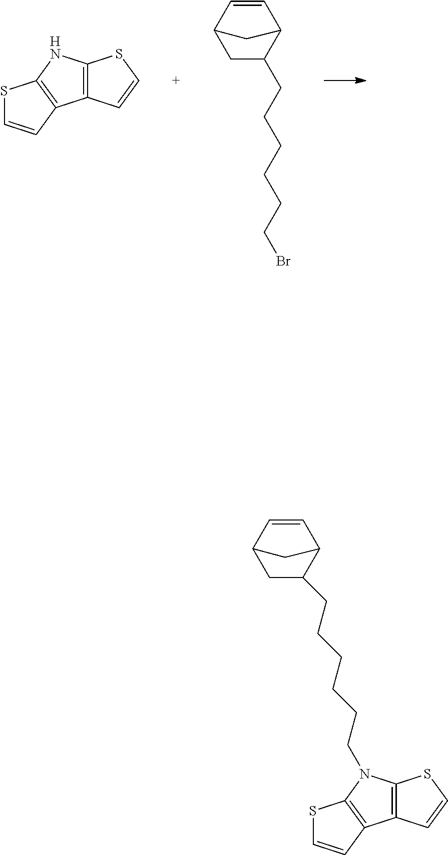 [SMILES: c1cc2c([nH]c3sccc32)s1 ; BrCCCCCCC1CC2C=CC1C2 ; C1=CC2CC1CC2CCCCCCn1c2sccc2c2ccsc21]

Under a nitrogen atmosphere, 7H-dithieno[2,3-b: 3′,2′-d]pyrrole (63 g, 0.35 mol) and sodium hydride (15 g, 0.62 mol) were mixed and stirred in anhydrous DMF for 2 h, followed by dropwise addition of 5-(6-bromohexyl) bicyclo[2.2.1]hept-2-ene (134 g, 0.52 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:4). The product was dried under vacuum at 60° C. for 10 h to give a white solid (100 g, yield 80%).

### Embodiment 6

### Synthesis of Cycloolefin Monomer HM11 (Side-Chain Carbon Number=1)

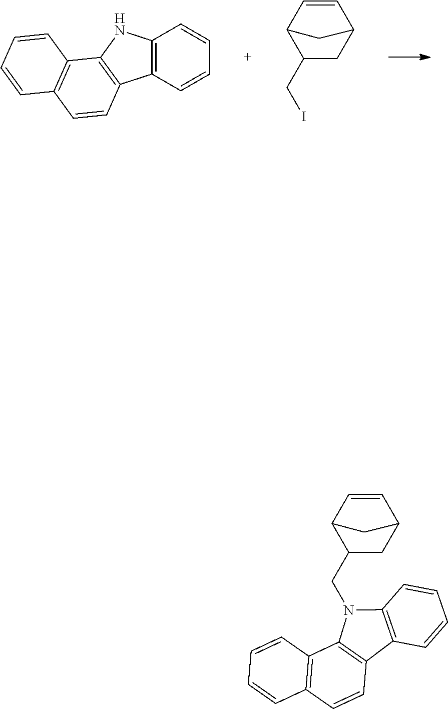 [SMILES: c1ccc2c(c1)ccc1c3ccccc3[nH]c21 ; ICC1CC2C=CC1C2 ; C1=CC2CC1CC2Cn1c2ccccc2c2ccc3ccccc3c21]

Under a nitrogen atmosphere, 11H-benzo[a]carbazole (76 g, 0.35 mol) and sodium hydride (15 g, 0.62 mol) were mixed and stirred in anhydrous N,N-dimethylformamide for 2 h, followed by dropwise addition of 5-(iodomethyl) bicyclo[2.2.1]hept-2-ene (98 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:6). The product was dried under vacuum at 60° C. for 10 h to give a white solid (96 g, yield 85%).

### Embodiment 7

### Synthesis of Cycloolefin Monomer HM15 (Side-Chain Carbon Number=1)

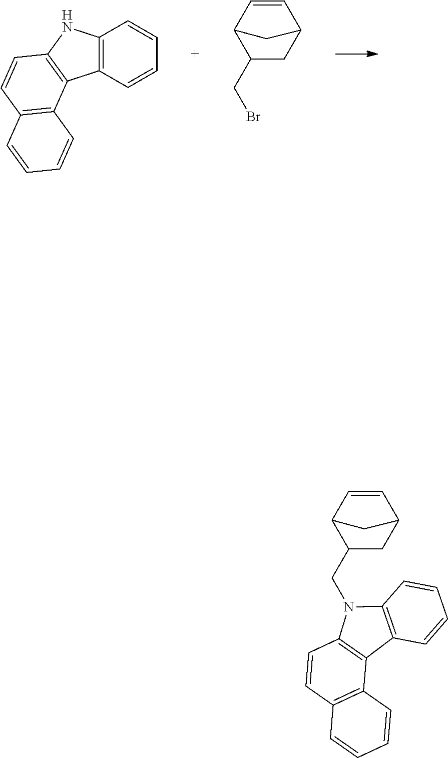 [SMILES: c1ccc2c(c1)ccc1[nH]c3ccccc3c12 ; BrCC1CC2C=CC1C2 ; C1=CC2CC1CC2Cn1c2ccccc2c2c3ccccc3ccc21]

Under a nitrogen atmosphere, 7H-benzo[c]carbazole (76 g, 0.35 mol) and sodium hydride (15 g, 0.62 mol) were mixed and stirred in anhydrous N,N-dimethylformamide for 2 h, followed by dropwise addition of 5-bromomethylbicyclo[2.2.1]hept-2-ene (76 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:6). The product was dried under vacuum at 60° C. for 10 h to give a white solid (74 g, yield 65%).

### Embodiment 8

### Synthesis of Cycloolefin Monomer HM13 (Side-Chain Carbon Number=3)

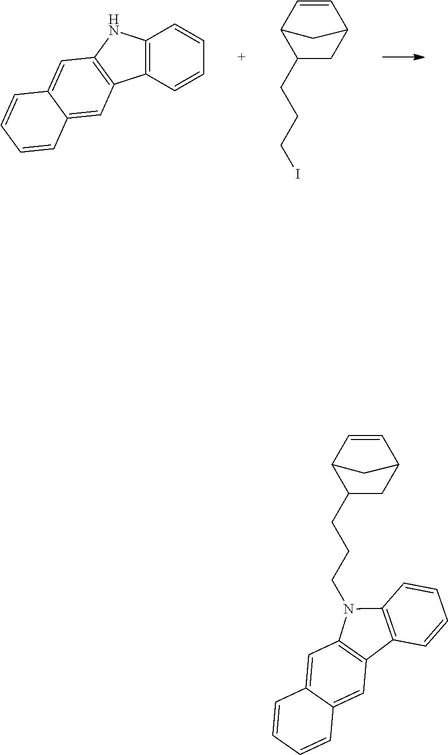 [SMILES: c1ccc2cc3c(cc2c1)[nH]c1ccccc13 ; ICCCC1CC2C=CC1C2 ; C1=CC2CC1CC2CCCn1c2ccccc2c2cc3ccccc3cc21]

Under a nitrogen atmosphere, 5H-benzo[b]carbazole (76 g, 0.35 mol) and sodium hydride (15 g, 0.62 mol) were mixed and stirred in anhydrous N,N-dimethylformamide for 2 h, followed by dropwise addition of 5-(3-iodopropyl) bicyclo[2.2.1]hept-2-ene (107 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:10). The product was dried under vacuum at 60° C. for 10 h to give a white solid (104 g, yield 85%).

### Embodiment 9

### Synthesis of Cycloolefin Monomer HM15 (Side-Chain Carbon Number=2)

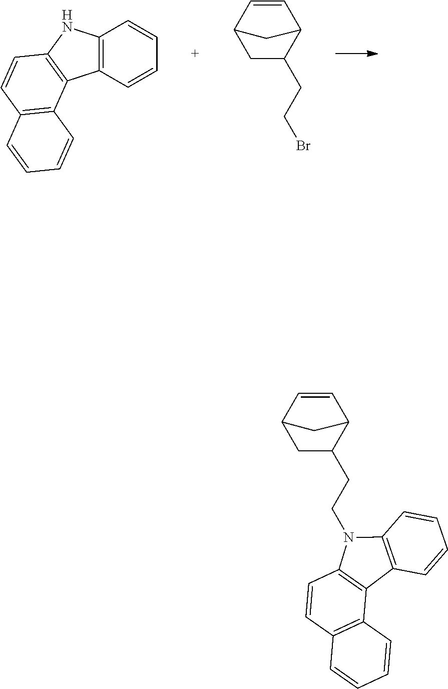 [SMILES: c1ccc2c(c1)ccc1[nH]c3ccccc3c12 ; BrCCC1CC2C=CC1C2 ; C1=CC2CC1CC2CCn1c2ccccc2c2c3ccccc3ccc21]

Under a nitrogen atmosphere, 7H-benzo[c]carbazole (76 g, 0.35 mol) and sodium hydride (15 g, 0.62 mol) were mixed and stirred in anhydrous N,N-dimethylformamide for 2 h, followed by dropwise addition of 5-(2-bromoethyl) bicyclo[2.2.1]hept-2-ene (82 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:6). The product was dried under vacuum at 60° C. for 10 h to give a white solid (96 g, yield 82%).

### Embodiment 10

### Synthesis of Cycloolefin Monomer HM15 (Side-Chain Carbon Number=4)

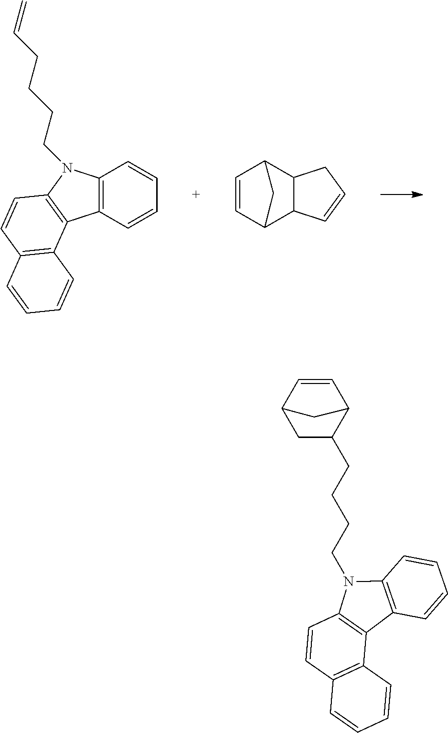 [SMILES: C=CCCCCn1c2ccccc2c2c3ccccc3ccc21 ; C1=CC2C3C=CC(C3)C2C1 ; C1=CC2CC1CC2CCCCn1c2ccccc2c2c3ccccc3ccc21]

7-(Hex-5-en-1-yl)-7H-benzo[c]carbazole (180 g, 0.60 mol), dicyclopentadiene (13 g, 0.10 mol) and 2,6-di-tert-butyl-p-cresol (0.5 g, 2.3 mmol) were added to a 250 mL reactor, purged with nitrogen to 5 MPa, and stirred at 200° C. for 20 h. After cooling, the mixture was purified by column chromatography with gradient elution (V (ethyl acetate): V (petroleum ether)=0-1:10). The product was dried under vacuum at 60° C. for 10 h to give a white solid (40 g, yield 54%).

### Embodiment 11

### Synthesis of Cycloolefin Monomer HM15 (Side-Chain Carbon Number=0)

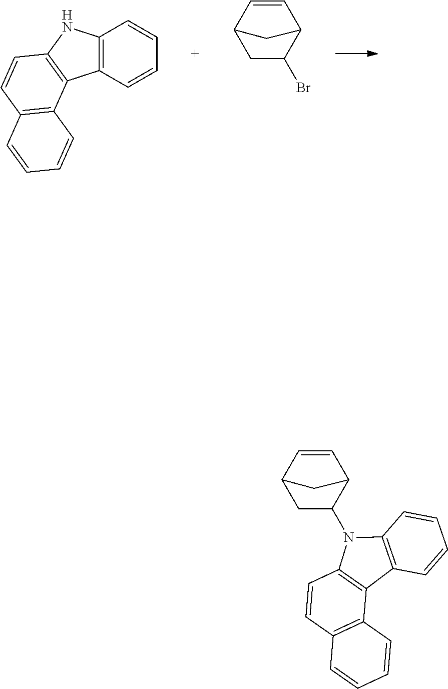 [SMILES: c1ccc2c(c1)ccc1[nH]c3ccccc3c12 ; BrC1CC2C=CC1C2 ; C1=CC2CC1CC2n1c2ccccc2c2c3ccccc3ccc21]

Under a nitrogen atmosphere, 7H-benzo[c]carbazole (76 g, 0.35 mol) and sodium hydride (15 g, 0.62 mol) were mixed and stirred in anhydrous N,N-dimethylformamide for 2 h, followed by dropwise addition of 5-bromobicyclo[2.2.1]hept-2-ene (71 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:5). The product was dried under vacuum at 60° C. for 10 h to give a white solid (65 g, yield 60%).

### Embodiment 12

### Synthesis of Cycloolefin Monomer HM14 (Side-Chain Carbon Number=1)

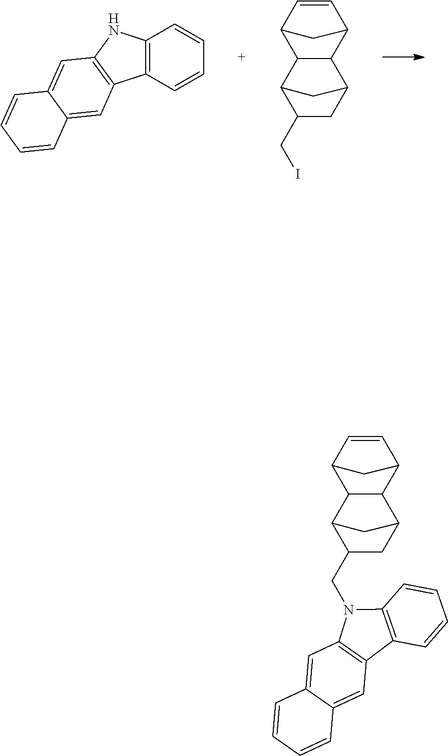 [SMILES: c1ccc2cc3c(cc2c1)[nH]c1ccccc13 ; ICC1CC2CC1C1C3C=CC(C3)C21 ; C1=CC2CC1C1C3CC(Cn4c5ccccc5c5cc6ccccc6cc54)C(C3)C21]

Under a nitrogen atmosphere, 5H-benzo[b]carbazole (76 g, 0.35 mol) and sodium hydride (15 g, 0.62 mol) were mixed and stirred in anhydrous N,N-dimethylformamide for 2 h, followed by dropwise addition of 2-(iodomethyl)-1,2,3,4,4a,5,8,8a-octahydro-1,4:5,8-dimethanonaphthalene (123 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:4). The product was dried under vacuum at 60° C. for 10 h to give a white solid (102 g, yield 75%).

### Embodiment 13

### Synthesis of Cycloolefin Monomer HM16 (Side-Chain Carbon Number=1)

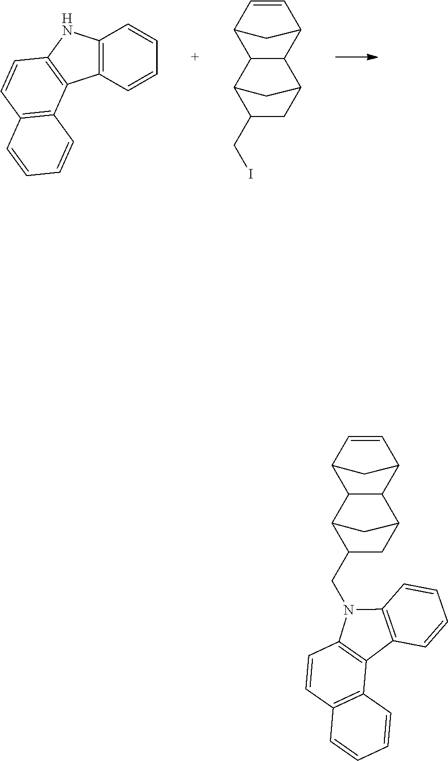 [SMILES: c1ccc2c(c1)ccc1[nH]c3ccccc3c12 ; ICC1CC2CC1C1C3C=CC(C3)C21 ; C1=CC2CC1C1C3CC(Cn4c5ccccc5c5c6ccccc6ccc54)C(C3)C21]

Under a nitrogen atmosphere, 7H-benzo[c]carbazole (76 g, 0.35 mol) and sodium hydride (15 g, 0.62 mol) were mixed and stirred in anhydrous N,N-dimethylformamide for 2 h, followed by dropwise addition of 2-(iodomethyl)-1,2,3,4,4a,5,8,8a-octahydro-1,4:5,8-dimethanonaphthalene (104 g, 0.41 mol), and the reaction was carried out at 120° C. for 24 h. The reaction mixture was extracted three times with ethyl acetate, rotary-evaporated to dryness, and purified by column chromatography with gradient elution (V (ethyl acetate): V (petroleum ether)=0-1:4). The product was dried under vacuum at 60° C. for 10 h to give a white solid (114 g, yield 84%).

### Embodiment 14

### Synthesis of Cycloolefin Monomer HM13 (Side-Chain Carbon Number=5)

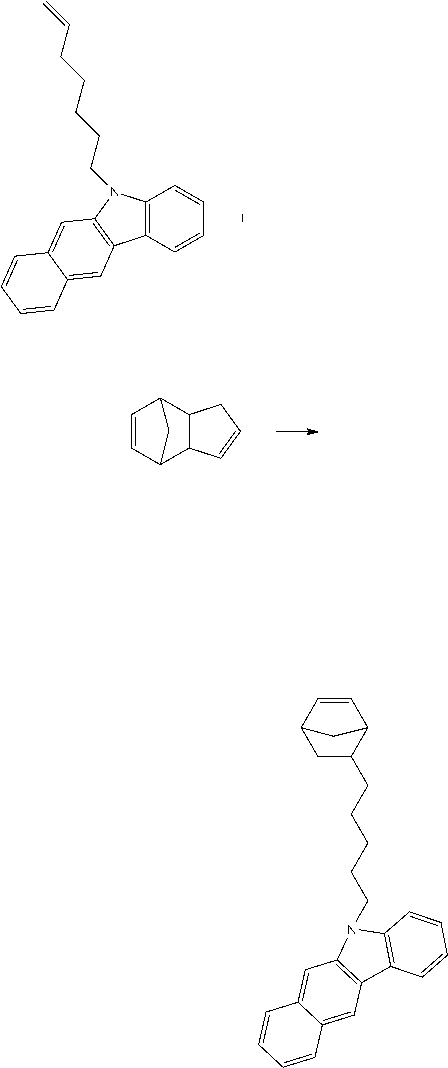 [SMILES: C=CCCCCCn1c2ccccc2c2cc3ccccc3cc21 ; C1=CC2C3C=CC(C3)C2C1 ; C1=CC2CC1CC2CCCCCn1c2ccccc2c2cc3ccccc3cc21]

5-(Hept-6-en-1-yl)-5H-benzo[b]carbazole (188 g, 0.60 mol), dicyclopentadiene (13 g, 0.10 mol) and 2,6-di-tert-butyl-p-cresol (0.5 g, 2.3 mmol) were added to a 250 mL reactor, purged with nitrogen to 5 MPa, and stirred at 200° C. for 20 h. After cooling, the mixture was purified by column chromatography with gradient elution (V (ethyl acetate): V (petroleum ether)=0-1:10). The product was dried under vacuum at 60° C. for 10 h to give a white solid (50 g, yield 65%).

### Embodiment 15

### Synthesis of Cycloolefin Monomer HM11 (Side-Chain Carbon Number=6)

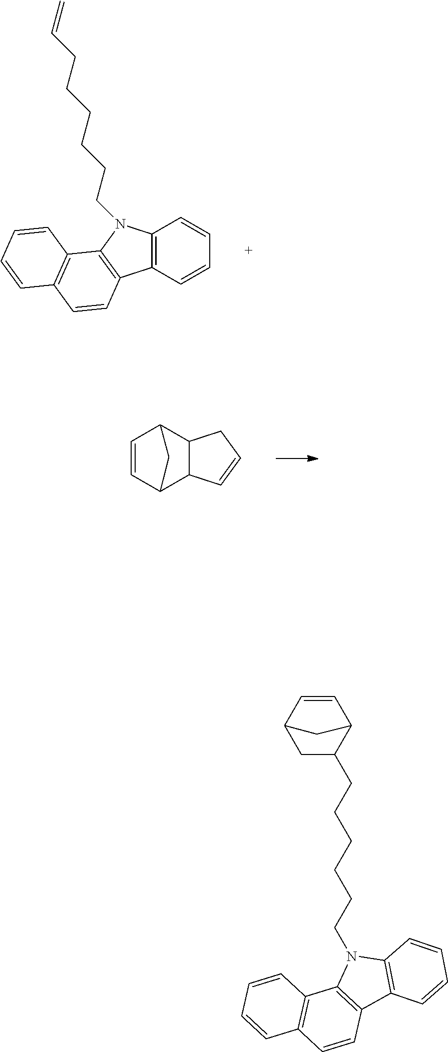 [SMILES: C=CCCCCCCn1c2ccccc2c2ccc3ccccc3c21 ; C1=CC2C3C=CC(C3)C2C1 ; C1=CC2CC1CC2CCCCCCn1c2ccccc2c2ccc3ccccc3c21]

11-(Oct-7-en-1-yl)-11H-benzo[a]carbazole (188 g, 0.60 mol), dicyclopentadiene (13 g, 0.10 mol) and 2,6-di-tert-butyl-p-cresol (0.5 g, 2.3 mmol) were added to a 250 mL reactor, purged with nitrogen to 5 MPa, and stirred at 200° C. for 20 h. After cooling, the mixture was purified by column chromatography with gradient elution (V (ethyl acetate): V (petroleum ether)=0-1:10). The product was dried under vacuum at 60° C. for 10 h to give a white solid (47 g, yield 60%).

### Embodiment 16

The cyclic olefin polymer has the structure:

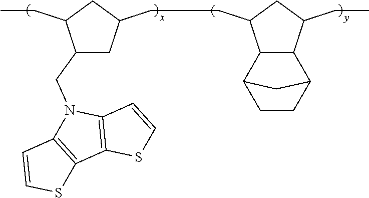 [SMILES: CCC1CC(CCCC2CC(CC)C3C4CCC(C4)C23)CC1Cn1c2ccsc2c2sccc21]

wherein the degrees of polymerization are x=900, y=100. The synthesis steps are as follows:

At room temperature, 28.21 g (0.099 mol) of monomer HM7 prepared in Embodiment 1 and 1.76 g (0.011 mol) of monomer M3 were added into a dried polymerization flask. Then 500 mL of dried, degassed dichloromethane was added, and the mixture was stirred magnetically for 5 min to obtain a homogeneous solution. Subsequently, 0.094 g (0.110 mmol) of catalyst (G2) was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 82.77 g of p-toluenesulfonyl hydrazide and 69.98 g of tripropylamine were added into a round-bottom flask equipped with a condenser, 0.028 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.66, an Abbe number of 22, a glass transition temperature of 132° C., a water absorption of less than 0.01%, and a visible-light transmittance of more than 90%.

### Embodiment 17

The cyclic olefin polymer has the structure:

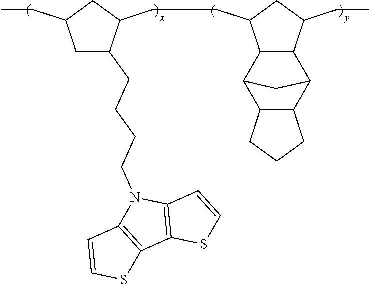 [SMILES: CCC1CC(CCCCn2c3ccsc3c3sccc32)C(CCCC2CC(CC)C3C4CC(C5CCCC54)C23)C1]

wherein the degrees of polymerization are x=400, y=200. The synthesis steps are as follows:

At room temperature, 17.01 g (0.052 mol) of monomer HM7 prepared in Embodiment 2 and 5.20 g (0.026 mol) of monomer M5 were added into a dried polymerization flask. Then 500 mL of dried, degassed dichloromethane was added, and the mixture was stirred magnetically for 5 min to obtain a homogeneous solution. Subsequently, 0.110 g (0.130 mmol) of catalyst G2 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 74.40 g of p-toluenesulfonyl hydrazide and 62.92 g of tripropylamine were added into a round-bottom flask equipped with a condenser, 0.035 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.63, an Abbe number of 25, a glass transition temperature of 138° C., a water absorption of less than 0.01%, and a visible-light transmittance of more than 90%.

### Embodiment 18

The cyclic olefin polymer has the structure:

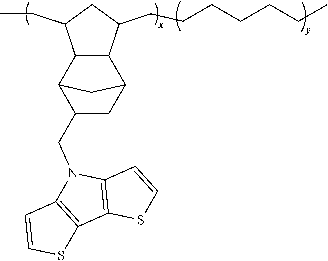

wherein the degrees of polymerization are x=500, y=100. The synthesis steps are as follows:

At room temperature, 19.31 g (0.055 mol) of monomer HM8 prepared in Embodiment 3 and 0.75 g (0.011 mol) of monomer M7 were added into a dried polymerization flask. Then 500 mL of dried, degassed dichloromethane was added, and the mixture was stirred magnetically for 5 min to obtain a homogeneous solution. Subsequently, 0.097 g (0.110 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 61.38 g of p-toluenesulfonyl hydrazide and 51.91 g of tripropylamine were added into a round-bottom flask equipped with a condenser, 0.029 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.63, an Abbe number of 24, a glass transition temperature of 173° C., a water absorption of less than 0.01%, and a visible-light transmittance of more than 90%.

### Embodiment 19

The cyclic olefin polymer has the structure:

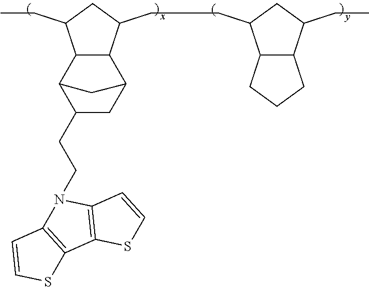 [SMILES: CCC1CC(CCCC2CC(CC)C3C4CC(CC4CCn4c5ccsc5c5sccc54)C23)C2CCCC12]

wherein the degrees of polymerization are x=480, y=80. The synthesis steps are as follows:

At room temperature, 26.28 g (0.072 mol) of monomer HM4 prepared in Embodiment 4 and 1.61 g (0.012 mol) of monomer M2 were added into a dried polymerization flask. Then 500 mL of dried, degassed dichloromethane was added, and the mixture was stirred magnetically for 5 min to obtain a homogeneous solution. Subsequently, 0.133 g (0.150 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 61.38 g of p-toluenesulfonyl hydrazide and 51.91 g of tripropylamine were added into a round-bottom flask equipped with a condenser, 0.029 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.62, an Abbe number of 25, a glass transition temperature of 175° C., a water absorption of less than 0.01%, and a visible-light transmittance of more than 90%.

### Embodiment 20

The cyclic olefin polymer has the structure:

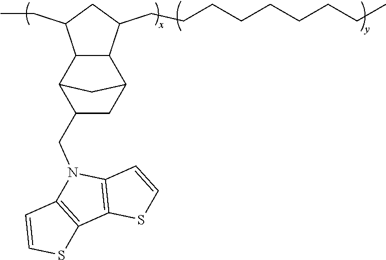

wherein the degrees of polymerization are x=400, y=100. The synthesis steps are as follows:

At room temperature, 21.06 g (0.060 mol) of monomer HM8 prepared in Embodiment 3 and 1.65 g (0.015 mol) of monomer M10 were added into a dried polymerization flask. Then 500 mL of dried, degassed dichloromethane was added, and the mixture was stirred magnetically for 5 min to obtain a homogeneous solution. Subsequently, 0.133 g (0.150 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 68.82 g of p-toluenesulfonyl hydrazide and 58.20 g of tripropylamine were added into a round-bottom flask equipped with a condenser, 0.029 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.62, an Abbe number of 25, a glass transition temperature of 170° C., a water absorption of less than 0.01%, and a visible-light transmittance of more than 90%.

### Embodiment 21

The cyclic olefin polymer has the structure:

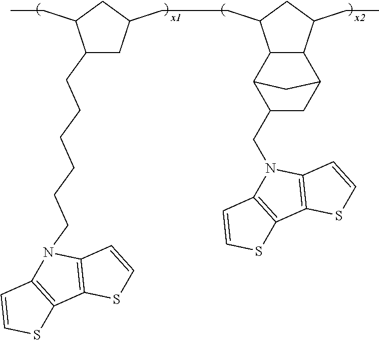 [SMILES: CCC1CC(CCCC2CC(CC)C3C4CC(Cn5c6ccsc6c6sccc65)C(C4)C23)CC1CCCCCCn1c2ccsc2c2sccc21]

wherein the degrees of polymerization are x₁=100, x₂=500. The synthesis steps are as follows:

At room temperature, 6.04 g (0.017 mol) of monomer HM3 prepared in Embodiment 5 and 29.84 g (0.085 mol) of monomer HM8 prepared in Embodiment 3 were added into a dried polymerization flask. Then 500 mL of dried, degassed dichloromethane was added, and the mixture was stirred magnetically for 5 min to obtain a homogeneous solution. Subsequently, 0.150 g (0.170 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 93.04 g of p-toluenesulfonyl hydrazide and 79.44 g of tripropylamine were added into a round-bottom flask equipped with a condenser, 0.022 g of 2,6-di-tert-butyl-4-methylphenol was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.65, an Abbe number of 23, a glass transition temperature of 165° C., a water absorption of less than 0.01%, and a visible-light transmittance of more than 90%.

### Embodiment 22

The cyclic olefin polymer has the structure:

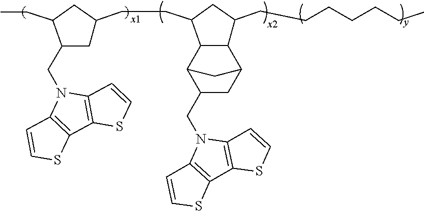

wherein the degrees of polymerization are x₁=150, x₂=300, y=75. The synthesis steps are as follows:

At room temperature, 7.13 g (0.025 mol) of monomer HM7 prepared in Embodiment 1, 17.55 g (0.050 mol) of monomer HM8 prepared in Embodiment 3 and 0.85 g (0.0125 mol) of monomer M7 were added into a dried polymerization flask. Then 500 mL of dried, degassed dichloromethane was added, and the mixture was stirred magnetically for 5 min to obtain a homogeneous solution. Subsequently, 0.147 g (0.167 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 12 g of Pd/Al₂O₃ catalyst were added into the reactor. After three vacuum-gas replacement cycles, 10 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.65, an Abbe number of 23, a glass transition temperature of 162° C., a water absorption of less than 0.01%, and a visible-light transmittance of more than 90%.

### Embodiment 23

The cyclic olefin polymer has the structure:

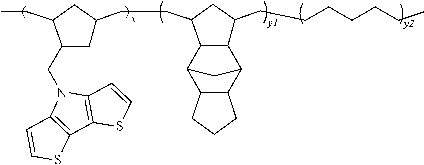

wherein the degrees of polymerization are x=300, y1=75, y2=75. The synthesis steps are as follows:

At room temperature, 22.80 g (0.080 mol) of monomer HM7 prepared in Embodiment 1, 4.01 g (0.020 mol) of monomer M5 and 1.36 g (0.020 mol) of monomer M7 were added into a dried polymerization flask. Then 500 mL of dried, degassed dichloromethane was added, and the mixture was stirred magnetically for 5 min to obtain a homogeneous solution. Subsequently, 0.236 g (0.267 mmol) of catalyst G3 was dissolved in 20 mL of dichloromethane and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 14 g of Pd/Al₂O₃ catalyst were added into the reactor. After three vacuum-gas replacement cycles, 20 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.63, an Abbe number of 24, a glass transition temperature of 130° C., a water absorption of less than 0.01%, and a visible-light transmittance of more than 90%.

### Embodiment 24

The cyclic olefin polymer has the structure:

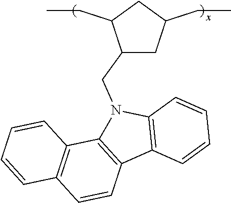 [SMILES: CCC1CC(CC)C(Cn2c3ccccc3c3ccc4ccccc4c32)C1]

wherein the degree of polymerization is x=500. The synthesis steps are as follows:

At room temperature, 20.01 g (0.062 mol) of monomer HM11 prepared in Embodiment 6 were added into a dried polymerization flask. Then 500 mL of dried, degassed chlorobenzene was added, and the mixture was stirred magnetically for 5 min to obtain a homogeneous solution. Subsequently, 0.110 g (0.124 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 57.62 g of p-toluenesulfonyl hydrazide and 48.81 g of tripropylamine were added into a round-bottom flask equipped with a condenser, 0.027 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.67, an Abbe number of 17, a glass transition temperature of 180° C., a water absorption of less than 0.01%, and a visible-light transmittance of more than 90%.

### Embodiment 25

The cyclic olefin polymer has the structure:

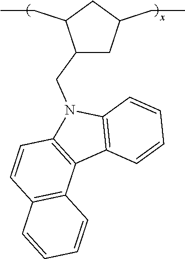 [SMILES: CCC1CC(CC)C(Cn2c3ccccc3c3c4ccccc4ccc32)C1]

wherein the degree of polymerization is x=500. The synthesis steps are as follows:

At room temperature, 20.01 g (0.062 mol) of monomer HM15 prepared in Embodiment 7 were added into a dried polymerization flask. Then 500 mL of dried, degassed chlorobenzene was added, and the mixture was stirred magnetically for 5 min to obtain a homogeneous solution. Subsequently, 0.110 g (0.124 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 57.62 g of p-toluenesulfonyl hydrazide and 48.81 g of tripropylamine were added into a round-bottom flask equipped with a condenser, 0.027 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.70, an Abbe number of 14, a glass transition temperature of 175° C., a water absorption of less than 0.01%, and a visible-light transmittance of more than 90%.

### Embodiment 26

The cyclic olefin polymer has the structure:

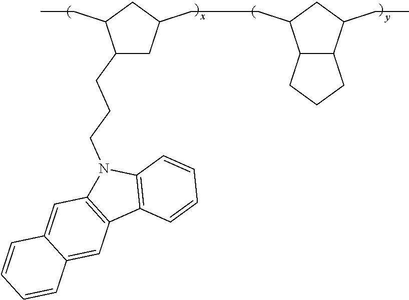 [SMILES: CCC1CC(CCCC2CC(CC)C3CCCC23)CC1CCCn1c2ccccc2c2cc3ccccc3cc21]

wherein the degrees of polymerization are x=400, y=100. The synthesis steps are as follows:

At room temperature, 18.28 g (0.052 mol) of monomer HM13 prepared in Embodiment 8 and 1.74 g (0.013 mol) of monomer M2 were added into a dried polymerization flask. Then 500 mL of dried, degassed chlorobenzene was added, and the mixture was stirred magnetically for 5 min to obtain a homogeneous solution. Subsequently, 0.108 g (0.128 mmol) of catalyst G2 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 59.52 g of p-toluenesulfonyl hydrazide and 50.33 g of tripropylamine were added into a round-bottom flask equipped with a condenser, 0.028 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.66, an Abbe number of 18, a glass transition temperature of 165° C., a water absorption of less than 0.01%, and a visible-light transmittance of more than 90%.

### Embodiment 27

The cyclic olefin polymer has the structure:

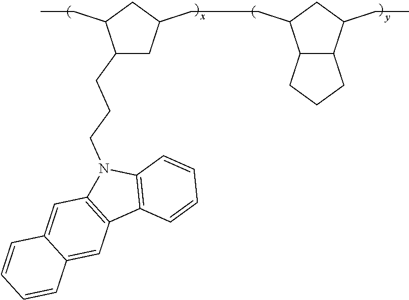 [SMILES: CCC1CC(CCCC2CC(CC)C3CCCC23)CC1CCCn1c2ccccc2c2cc3ccccc3cc21]

wherein the degrees of polymerization are x=400, y=200. The synthesis steps are as follows:

At room temperature, 18.28 g (0.052 mol) of monomer HM13 prepared in Embodiment 8 and 3.48 g (0.026 mol) of monomer M2 were added into a dried polymerization flask. Then 500 mL of dried, degassed chlorobenzene was added, and the mixture was stirred magnetically for 5 min to obtain a homogeneous solution. Subsequently, 0.108 g (0.128 mmol) of catalyst G2 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 71.61 g of p-toluenesulfonyl hydrazide and 60.56 g of tripropylamine were added into a round-bottom flask equipped with a condenser, 0.028 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.65, an Abbe number of 19, a glass transition temperature of 162° C., a water absorption of less than 0.01%, and a visible-light transmittance of more than 90%.

### Embodiment 28

The cyclic olefin polymer has the structure:

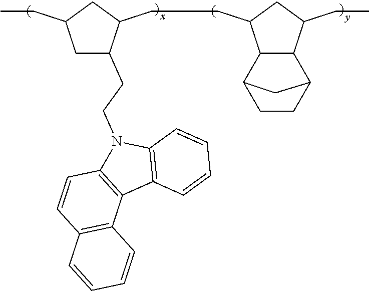 [SMILES: CCC1CC(CCCC2CC(CC)C3C4CCC(C4)C23)C(CCn2c3ccccc3c3c4ccccc4ccc32)C1]

wherein the degrees of polymerization are x=400, y=200. The synthesis steps are as follows:

At room temperature, 19.91 g (0.059 mol) of monomer HM15 prepared in Embodiment 9 and 4.75 g (0.030 mol) of monomer M3 were added into a dried polymerization flask. Then 500 mL of dried, degassed chlorobenzene was added, and the mixture was stirred magnetically for 5 min to obtain a homogeneous solution. Subsequently, 0.126 g (0.148 mmol) of catalyst G2 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 82.77 g of p-toluenesulfonyl hydrazide and 69.98 g of tripropylamine were added into a round-bottom flask equipped with a condenser, 0.028 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.65, an Abbe number of 19, a glass transition temperature of 163° C., a water absorption of less than 0.01%, and a visible-light transmittance of more than 90%.

### Embodiment 29

The cyclic olefin polymer has the structure:

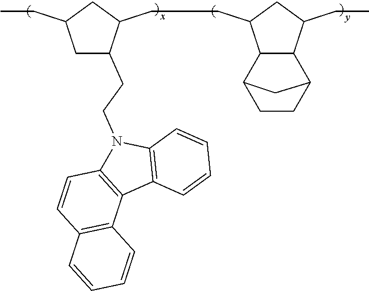 [SMILES: CCC1CC(CCCC2CC(CC)C3C4CCC(C4)C23)C(CCn2c3ccccc3c3c4ccccc4ccc32)C1]

wherein the degrees of polymerization are x=300, y=300. The synthesis steps are as follows:

At room temperature, 14.85 g (0.044 mol) of monomer HM15 prepared in Embodiment 9 and 7.04 g (0.044 mol) of monomer M3 were added into a dried polymerization flask. Then 500 mL of dried, degassed chlorobenzene was added, and the mixture was stirred magnetically for 5 min to obtain a homogeneous solution. Subsequently, 0.126 g (0.148 mmol) of catalyst G2 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 82.77 g of p-toluenesulfonyl hydrazide and 69.98 g of tripropylamine were added into a round-bottom flask equipped with a condenser, 0.028 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.64, an Abbe number of 20, a glass transition temperature of 161° C., a water absorption of less than 0.01%, and a visible-light transmittance of more than 90%.

### Embodiment 30

The cyclic olefin polymer has the structure:

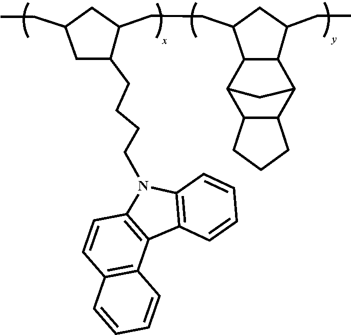

wherein the degrees of polymerization are x=250, y=250. The synthesis steps are as follows:

At room temperature, 14.62 g (0.040 mol) of monomer HM15 prepared in Embodiment 10 and 8.01 g (0.040 mol) of monomer M5 were added into a dried polymerization flask. Then 500 mL of dried, degassed chlorobenzene was added, and the mixture was stirred magnetically for 5 min to obtain a homogeneous solution. Subsequently, 0.135 g (0.160 mmol) of catalyst G2 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 74.40 g of p-toluenesulfonyl hydrazide and 62.92 g of tripropylamine were added into a round-bottom flask equipped with a condenser, 0.035 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.63, an Abbe number of 23, a glass transition temperature of 170° C., a water absorption of less than 0.01%, and a visible-light transmittance of more than 90%.

### Embodiment 31

The cyclic olefin polymer has the structure:

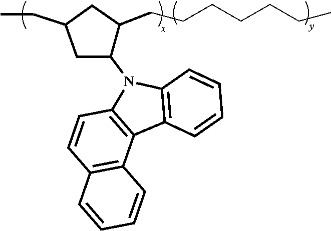

wherein the degrees of polymerization are x=400, y=100. The synthesis steps are as follows:

At room temperature, 18.56 g (0.060 mol) of monomer HM15 prepared in Embodiment 11 and 1.02 g (0.015 mol) of monomer M7 were added into a dried polymerization flask. Then 500 mL of dried, degassed chlorobenzene was added, and the mixture was stirred magnetically for 5 min to obtain a homogeneous solution. Subsequently, 0.133 g (0.150 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 69.75 g of p-toluenesulfonyl hydrazide and 58.98 g of tripropylamine were added into a round-bottom flask equipped with a condenser, 0.033 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.69, an Abbe number of 15, a glass transition temperature of 168° C., a water absorption of less than 0.01%, and a visible-light transmittance of more than 90%.

### Embodiment 32

The cyclic olefin polymer has the structure:

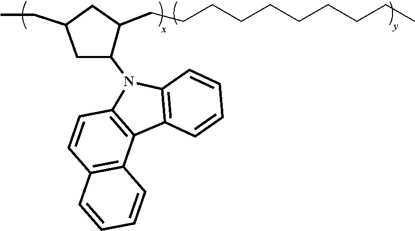

wherein the degrees of polymerization are x=700, y=100. The synthesis steps are as follows:

At room temperature, 19.49 g (0.063 mol) of monomer HM15 prepared in Embodiment 11 and 0.99 g (0.009 mol) of monomer M10 were added into a dried polymerization flask. Then 500 mL of dried, degassed chlorobenzene was added, and the mixture was stirred magnetically for 5 min to obtain a homogeneous solution. Subsequently, 0.078 g (0.090 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

The above polymerization product, 66.03 g of p-toluenesulfonyl hydrazide and 55.84 g of tripropylamine were added into a round-bottom flask equipped with a condenser, 0.020 g of 2,6-di-tert-butyl-4-methylphenol (BHT) was added, and chlorobenzene was used as solvent to dissolve the mixture by stirring. The system was then subjected to vacuum-nitrogen purging cycles, and reacted at 120° C. for 16 h under a nitrogen atmosphere. The polymer solution was poured into anhydrous ethanol to precipitate, then filtered and washed, and the product was dried under vacuum at 60° C. for 18 h to obtain the hydrogenated product, namely the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.69, an Abbe number of 15, a glass transition temperature of 165° C., a water absorption of less than 0.01%, and a visible-light transmittance of more than 90%.

### Embodiment 33

The cyclic olefin polymer has the structure:

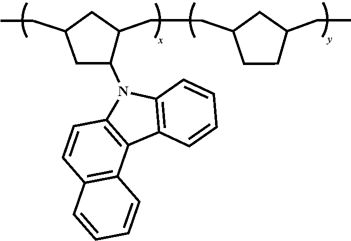

wherein the degrees of polymerization are x=400, y=100. The synthesis steps are as follows:

At room temperature, 24.75 g (0.080 mol) of monomer HM15 prepared in Embodiment 11 and 1.88 g (0.020 mol) of monomer M8 were added into a dried polymerization flask. Then 500 mL of dried, degassed chlorobenzene was added, and the mixture was stirred magnetically for 5 min to obtain a homogeneous solution. Subsequently, 0.173 g (0.196 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 13 g of Pd/Al₂O₃ catalyst were added into the reactor. After three vacuum-gas replacement cycles, 10 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.68, an Abbe number of 15, a glass transition temperature of 173° C., a water absorption of less than 0.01%, and a visible-light transmittance of more than 90%.

### Embodiment 34

The cyclic olefin polymer has the structure:

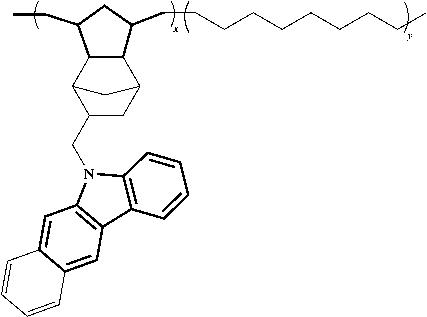

wherein the degrees of polymerization are x=480, y=80. The synthesis steps are as follows:

At room temperature, 25.71 g (0.066 mol) of monomer HM14 prepared in Embodiment 12 and 1.21 g (0.011 mol) of monomer M10 were added into a dried polymerization flask. Then 500 mL of dried, degassed chlorobenzene was added, and the mixture was stirred magnetically for 5 min to obtain a homogeneous solution. Subsequently, 0.117 g (0.132 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 13 g of Pd/Al₂O₃ catalyst were added into the reactor. After three vacuum-gas replacement cycles, 10 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.66, an Abbe number of 18, a glass transition temperature of 185° C., a water absorption of less than 0.01%, and a visible-light transmittance of more than 90%.

### Embodiment 35

The cyclic olefin polymer has the structure:

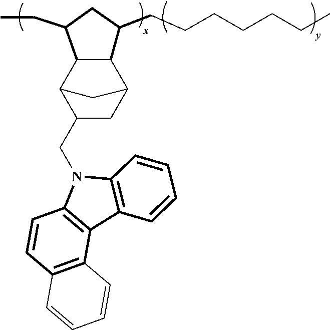

wherein the degrees of polymerization are x=400, y=100. The synthesis steps are as follows:

At room temperature, 20.25 g (0.052 mol) of monomer HM16 prepared in Embodiment 13 and 0.90 g (0.013 mol) of monomer M7 were added into a dried polymerization flask. Then 500 mL of dried, degassed chlorobenzene was added, and the mixture was stirred magnetically for 5 min to obtain a homogeneous solution. Subsequently, 0.117 g (0.132 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 11 g of Pd/Al₂O₃ catalyst were added into the reactor. After three vacuum-gas replacement cycles, 20 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.67, an Abbe number of 17, a glass transition temperature of 184° C., a water absorption of less than 0.01%, and a visible-light transmittance of more than 90%.

### Embodiment 36

The cyclic olefin polymer has the structure:

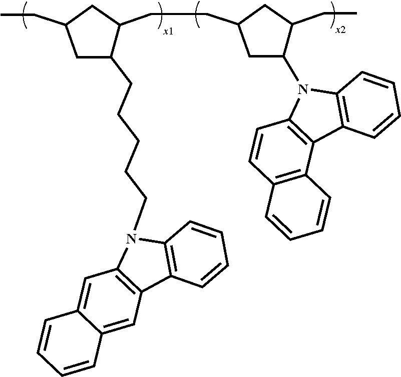

wherein the degrees of polymerization are x1=100, x2=500. The synthesis steps are as follows:

At room temperature, 5.69 g (0.015 mol) of monomer HM13 prepared in Embodiment 14 and 23.20 g (0.075 mol) of monomer HM15 prepared in Embodiment 11 were added into a dried polymerization flask. Then 500 mL of dried, degassed chlorobenzene was added, and the mixture was stirred magnetically for 5 min to obtain a homogeneous solution. Subsequently, 0.117 g (0.132 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product, 500 mL of chlorobenzene and 14 g of Pd/Al₂O₃ catalyst were added into the reactor. After three vacuum-gas replacement cycles, 20 MPa of hydrogen was introduced into the reactor, and the hydrogenation reaction was carried out at 120° C. for 15 h. The obtained hydrogenation reaction solution was filtered to recover the Pd/Al₂O₃ catalyst, thereby obtaining the hydrogenation product. The hydrogenation product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.68, an Abbe number of 15, a glass transition temperature of 172° C., a water absorption of less than 0.01%, and a visible-light transmittance of more than 90%.

### Embodiment 37

The cyclic olefin polymer has the structure:

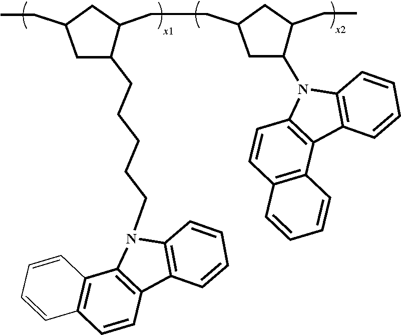

wherein the degrees of polymerization are x1=100, x2=500. The synthesis steps are as follows:

At room temperature, 6.69 g (0.017 mol) of monomer HM11 prepared in Embodiment 15 and 26.30 g (0.085 mol) of monomer HM15 prepared in Embodiment 11 were added into a dried polymerization flask. Then 500 mL of dried, degassed chlorobenzene was added, and the mixture was stirred magnetically for 5 min to obtain a homogeneous solution. Subsequently, 0.089 g (0.101 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product and 500 mL of chlorobenzene were added into the reactor, and three vacuum-gas replacement cycles were carried out. 0.128 g of nickel naphthenate and 2.24 mmol of triisobutylaluminum were placed in a Schlenk bottle, an appropriate amount of hydrogenation solvent was added and the mixture was mixed uniformly, and then aged in a water bath at a predetermined temperature. Under nitrogen protection, this mixture was injected into the high-pressure reactor with a syringe. Then 10 MPa of hydrogen was introduced into the reactor, and the hydrogenation reaction was carried out at 120° C. for 15 h. The obtained hydrogenation reaction product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.68, an Abbe number of 15, a glass transition temperature of 170° C., a water absorption of less than 0.01%, and a visible-light transmittance of more than 90%.

### Embodiment 38

The cyclic olefin polymer has the structure:

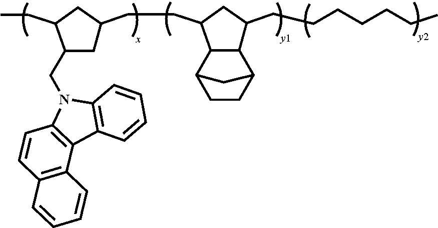

wherein the degrees of polymerization are x=300, y1=75, y2=75. The synthesis steps are as follows:

At room temperature, 25.88 g (0.080 mol) of monomer HM15 prepared in Embodiment 7, 3.20 g (0.020 mol) of monomer M3 and 1.36 g (0.020 mol) of monomer M7 were added into a dried polymerization flask. Then 500 mL of dried, degassed chlorobenzene was added, and the mixture was stirred magnetically for 5 min to obtain a homogeneous solution. Subsequently, 0.234 g (0.264 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product and 500 mL of chlorobenzene were added into the reactor, and three vacuum-gas replacement cycles were carried out. 0.120 g of nickel naphthenate and 2.10 mmol of triisobutylaluminum were placed in a Schlenk bottle, an appropriate amount of hydrogenation solvent was added and the mixture was mixed uniformly, and then aged in a water bath at a predetermined temperature. Under nitrogen protection, this mixture was injected into the high-pressure reactor with a syringe. Then 10 MPa of hydrogen was introduced into the reactor, and the hydrogenation reaction was carried out at 120° C. for 15 h. The obtained hydrogenation reaction product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.67, an Abbe number of 17, a glass transition temperature of 164° C., a water absorption of less than 0.01%, and a visible-light transmittance of more than 90%.

### Embodiment 39

The cyclic olefin polymer has the structure:

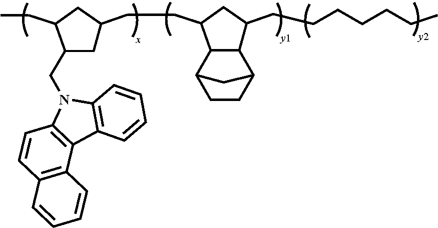

wherein the degrees of polymerization are x=250, y1=125, y2=62. The synthesis steps are as follows:

At room temperature, 25.88 g (0.080 mol) of monomer HM15 prepared in Embodiment 7, 6.41 g (0.040 mol) of monomer M3 and 1.36 g (0.020 mol) of monomer M7 were added into a dried polymerization flask. Then 500 mL of dried, degassed chlorobenzene was added, and the mixture was stirred magnetically for 5 min to obtain a homogeneous solution. Subsequently, 0.283 g (0.320 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product and 500 mL of chlorobenzene were added into the reactor, and three vacuum-gas replacement cycles were carried out. 0.132 g of nickel naphthenate and 3.52 mmol of triisobutylaluminum were placed in a Schlenk bottle, an appropriate amount of hydrogenation solvent was added and the mixture was mixed uniformly, and then aged in a water bath at a predetermined temperature. Under nitrogen protection, this mixture was injected into the high-pressure reactor with a syringe. Then 20 MPa of hydrogen was introduced into the reactor, and the hydrogenation reaction was carried out at 120° C. for 15 h. The obtained hydrogenation reaction product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.65, an Abbe number of 19, a glass transition temperature of 162° C., a water absorption of less than 0.01%, and a visible-light transmittance of more than 90%.

### Embodiment 40

The cyclic olefin polymer has the structure:

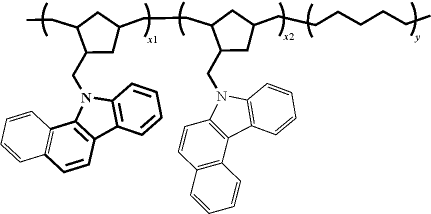

wherein the degrees of polymerization are x1=150, x2=300, y=75. The synthesis steps are as follows:

At room temperature, 8.08 g (0.025 mol) of monomer HM11 prepared in Embodiment 6, 16.17 g (0.050 mol) of monomer HM15 prepared in Embodiment 7 and 0.85 g (0.0125 mol) of monomer M7 were added into a dried polymerization flask. Then 500 mL of dried, degassed chlorobenzene was added, and the mixture was stirred magnetically for 5 min to obtain a homogeneous solution. Subsequently, 0.145 g (0.164 mmol) of catalyst G3 was dissolved in 20 mL of chlorobenzene and then rapidly injected into the round-bottom flask. The mixture was reacted under nitrogen at room temperature for 2 h, followed by addition of 300 equiv of ethyl vinyl ether (relative to the moles of catalyst) to terminate the reaction, and stirring was continued for 30 min. The polymer solution was poured into 1000 mL of anhydrous ethanol to precipitate, then filtered and washed, and the collected product was dried under vacuum at 40° C. for 16 h to obtain the polymerization product.

A high-pressure reactor was pre-dried under vacuum for 5 h, then the above polymerization product and 500 mL of chlorobenzene were added into the reactor, and three vacuum-gas replacement cycles were carried out. 0.102 g of nickel naphthenate and 1.78 mmol of triisobutylaluminum were placed in a Schlenk bottle, an appropriate amount of hydrogenation solvent was added and the mixture was mixed uniformly, and then aged in a water bath at a predetermined temperature. Under nitrogen protection, this mixture was injected into the high-pressure reactor with a syringe. Then 20 MPa of hydrogen was introduced into the reactor, and the hydrogenation reaction was carried out at 120° C. for 15 h. The obtained hydrogenation reaction product was poured into ethanol to precipitate, filtered and washed, and the precipitated product was placed in a vacuum oven and dried at 60° C. for 18 h to obtain the cyclic olefin polymer.

The polymerization method provided in this embodiment gives a monomer conversion of more than 99%, and the hydrogenation method provides a double-bond hydrogenation rate on the main chain of more than 99%. The final cyclic olefin polymer has a refractive index of 1.68, an Abbe number of 15, a glass transition temperature of 172° C., a water absorption of less than 0.01%, and a visible-light transmittance of more than 90%.

### Comparative Example 1

The cyclic olefin polymer has the structure:

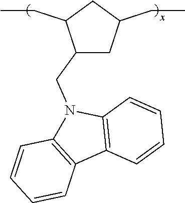 [SMILES: CCC1CC(CC)C(Cn2c3ccccc3c3ccccc32)C1]

wherein the degree of polymerization is x=500. The synthesis steps of the polymer are the same as those in Embodiment 25. The finally obtained polymer has a refractive index of 1.64, an Abbe number of 20, a glass transition temperature of 141° C., a water absorption of less than 0.01%, and a visible-light transmittance of more than 90%.

By comparison between Comparative Embodiment 1 and Embodiment 25, it can be seen that, through the introduction of a benzocarbazole group, the cyclic olefin polymer prepared in the present invention achieves comprehensive improvement in optical and thermal properties over the carbazole-based material of Comparative Example 1. The polymer in Embodiment 25 has a refractive index as high as 1.70, an increase of 0.06 compared with the value of 1.64 in Comparative Example 1, representing a qualitative breakthrough, and it is particularly suitable for high-refractive-index optical materials. In addition, the glass transition temperature (T_{g}) of the polymer in Embodiment 25 reaches 175° C., which is significantly higher than 141° C. in Comparative Example 1, indicating that introduction of the benzocarbazole group also significantly improves the thermal stability of the material. At the same time, the material of the present invention maintains excellent transparency (visible-light transmittance >90%) and extremely low water absorption (water absorption <0.01%) while achieving high refractive index. The comprehensive performance of these properties is far superior to that of Comparative Example 1.

After analyzing the products prepared in the other embodiments by ¹H-NMR and ¹³C-NMR spectroscopy, the results show that all target products have been successfully prepared.

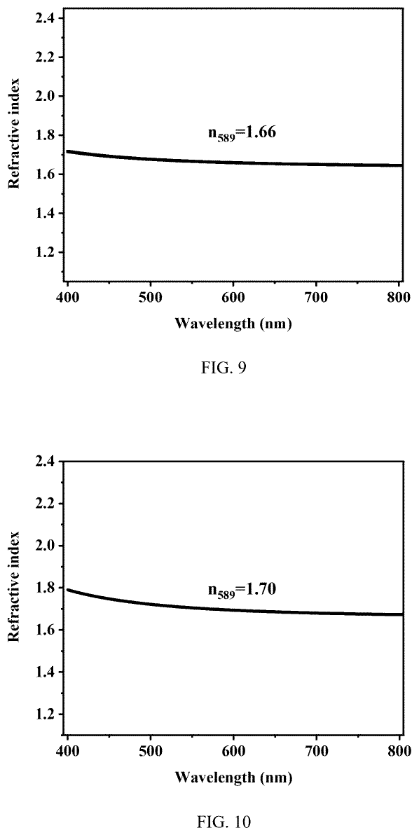

FIG. 9 is the refractive-index dispersion curve of the cyclic olefin polymer obtained in Embodiment 16 of the present invention. It can be seen from FIG. 9 that the cyclic olefin polymer prepared in Embodiment 16 has a refractive index as high as 1.66 in the visible-light range, exhibiting a high refractive index.

FIG. 10 is the refractive-index dispersion curve of the cyclic olefin polymer obtained in Embodiment 25 of the present invention. It can be seen from FIG. 10 that the cyclic olefin polymer prepared in Embodiment 25 has a refractive index as high as 1.70 in the visible-light range, exhibiting a high refractive index.

FIG. 11 is the differential scanning calorimetry curve of the cyclic olefin polymer obtained in Embodiment 18 of the present invention. It can be seen from FIG. 11 that the cyclic olefin polymer prepared in Embodiment 18 has a glass transition temperature as high as 173° C., exhibiting high thermal stability.

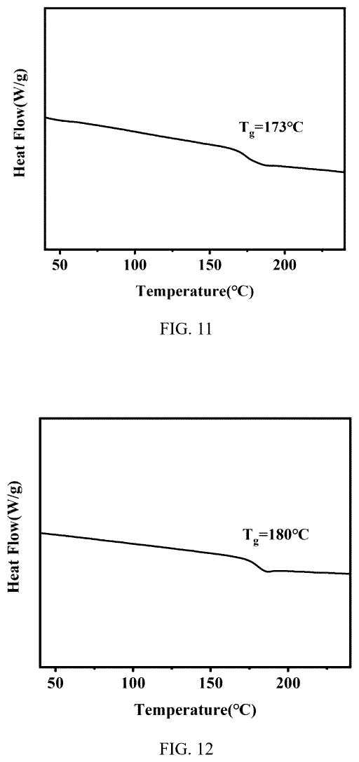

FIG. 12 is the differential scanning calorimetry curve of the cyclic olefin polymer obtained in Embodiment 24 of the present invention. It can be seen from FIG. 12 that the cyclic olefin polymer prepared in Embodiment 24 has a glass transition temperature as high as 180° C., exhibiting high thermal stability.

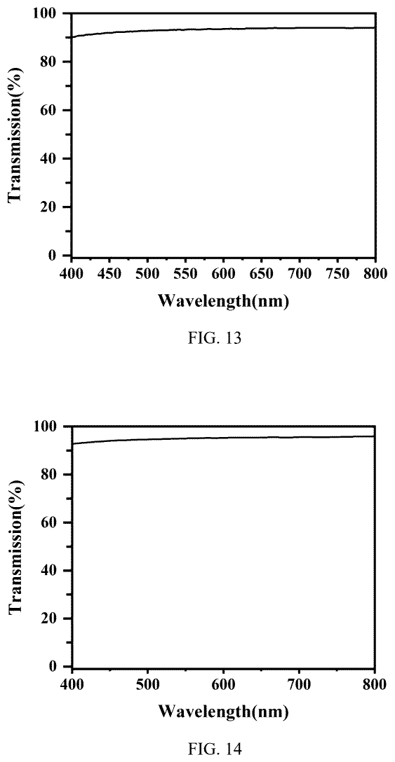

FIG. 13 is the transmittance curve of the cyclic olefin polymer obtained in Embodiment 20 of the present invention. It can be seen from FIG. 13 that the cyclic olefin polymer prepared in Embodiment 20 has a visible-light transmittance of more than 90%, exhibiting high transparency.

FIG. 14 is the transmittance curve of the cyclic olefin polymer obtained in Embodiment 31 of the present invention. It can be seen from FIG. 14 that the cyclic olefin polymer prepared in Embodiment 31 has a visible-light transmittance of more than 90%, exhibiting high transparency.

### Comparative Examples 2-4

Comparative Examples 2-4 are common commercial cyclic olefin polymers. The specific data are shown in Table 1.

TABLE 1
Performance of some commercial cyclic olefin polymers

| Comparative | | Refractive | Abbe | | Water | |
|---|---|---|---|---|---|---|
| Example | Company and Product | Index | Number | Transmittance | Absorption | T_{g} (° C.) |
| Comparative | Polyplastics | 1.53 | 56 | >90% | <0.01% | 140 |
| Example 2 | Topas ®5013 | | | | | |
| Comparative | Mitsui | 1.54 | 55 | >90% | <0.01% | 137 |
| Example 3 | APEL ™ APL5014 | | | | | |
| Comparative | Zeon ZEONEX ®K22R | 1.53 | 56 | >90% | <0.01% | 143 |
| Example 4 | | | | | | |

By comparison between Comparative Examples 2-4 and Embodiments 16-40, it can be seen that the cyclic olefin polymers of the present invention exhibit overall superior performance. The materials have a refractive index of 1.62-1.70, which is significantly higher than that of the commercial materials in the comparative examples. At the same time, the glass transition temperature reaches 130-185° C., demonstrating excellent heat resistance. More notably, while achieving high refractive index, the materials still maintain a transmittance of more than 90%, excellent transparency, and a water absorption of less than 0.01%, exhibiting outstanding environmental stability. Through unique molecular structure design, the present invention significantly improves the optical and thermal properties of cyclic olefin polymers and provides important technical support for the development of high-refractive-index optical materials.

The above-described embodiments are merely preferred embodiments of the present invention and are not intended to limit the scope of the present invention. Various modifications and improvements made to the technical solutions of the present invention by those of ordinary skill in the art without departing from the spirit of the design of the present invention shall fall within the protection scope defined by the claims of the present invention.

What is claimed is:

1. A cyclic olefin polymer, characterized in that it has a structure represented by formula (I): 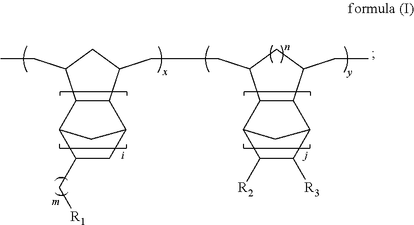
in formula (I), x and y are degrees of polymerization, 10≤x≤850, 0≤y≤750, but this does not indicate a block copolymer; the dashed line represents a bond or no bond; i and j are ring numbers, i is 0 or 1, j is 0 or 1; m and n are carbon atom numbers, 0≤m≤10, 0≤n≤4;
in formula (I), R₁ is selected from one of the following S1-S10: 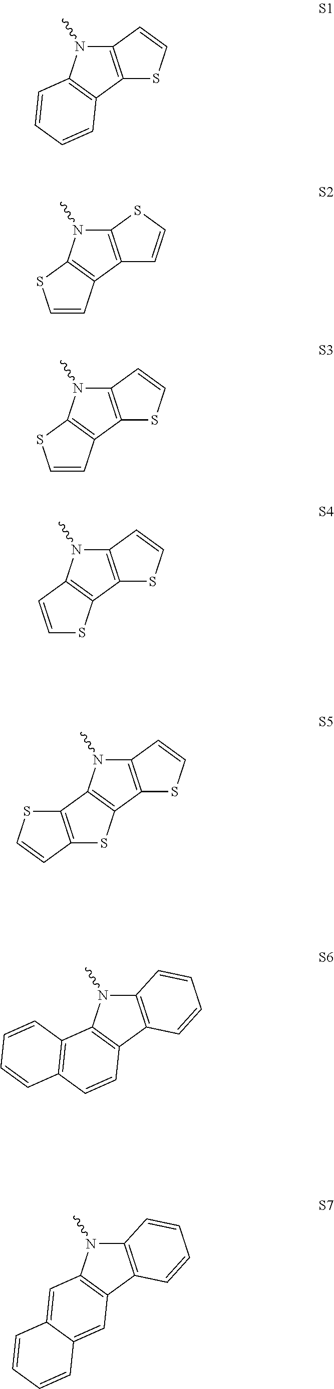 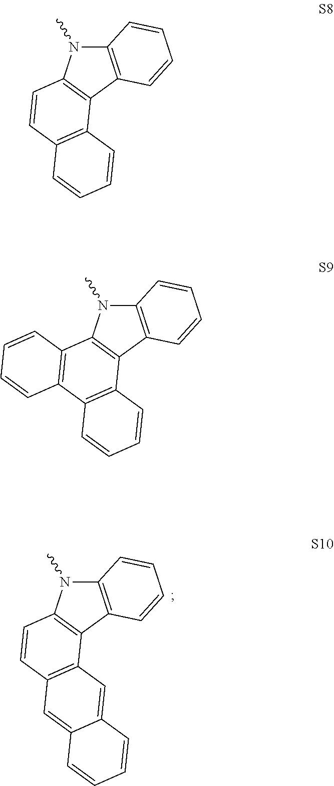
in formula (I), R₂ and R₃ are each independently selected from hydrogen, alkyl, and alkenyl, and a bond may or may not be formed between R₂ and R₃.

2. A preparation method of the cyclic olefin polymer according to claim 1, characterized in that the method comprises the steps of:
carrying out a ring-opening metathesis polymerization reaction of monomers under a protective atmosphere in the presence of a catalyst to obtain a polymerization reaction product;
subjecting the polymerization reaction product to a hydrogenation reaction to obtain the cyclic olefin polymer;
wherein the monomers comprise at least one compound of formula (II) and at least one compound of formula (III);
the compound of formula (II) has the structure: 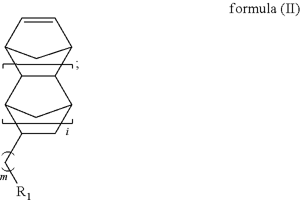
in formula (II), i is a ring number, i is 0 or 1; m is a carbon atom number, 0≤m≤10;
in formula (II), R₁ is the same as R₁ in claim 1;
the compound of formula (III) has the structure: 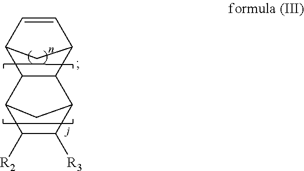
in formula (III), the dashed line represents a bond or no bond; j is a ring number, j is 0 or 1; n is a carbon atom number, 0≤n≤4; R₂ and R₃ are each independently selected from hydrogen, alkyl, and alkenyl, wherein a bond may or may not be formed between R₂ and R₃.

3. The preparation method of the cyclic olefin polymer according to claim 2, characterized in that the compound of formula (II) is selected from at least one of HM1-HM18: 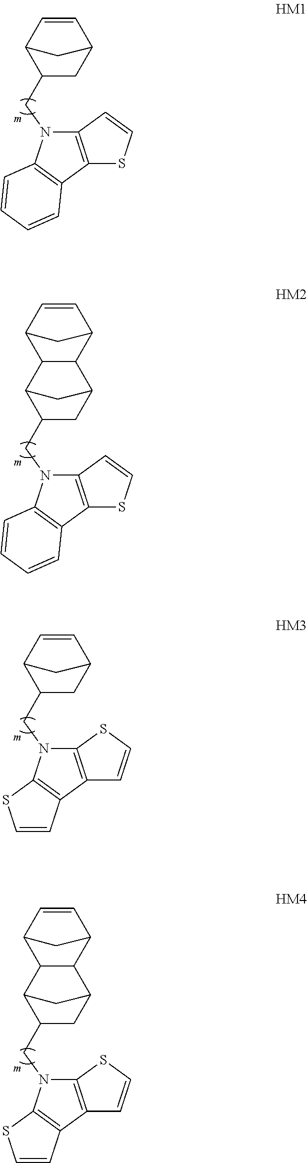 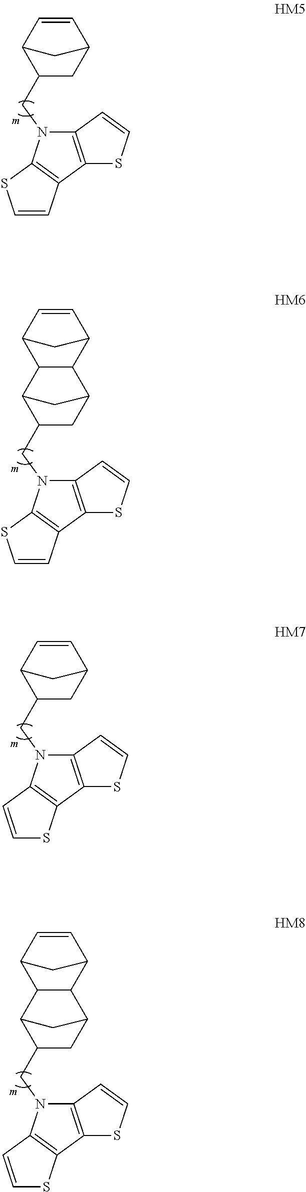 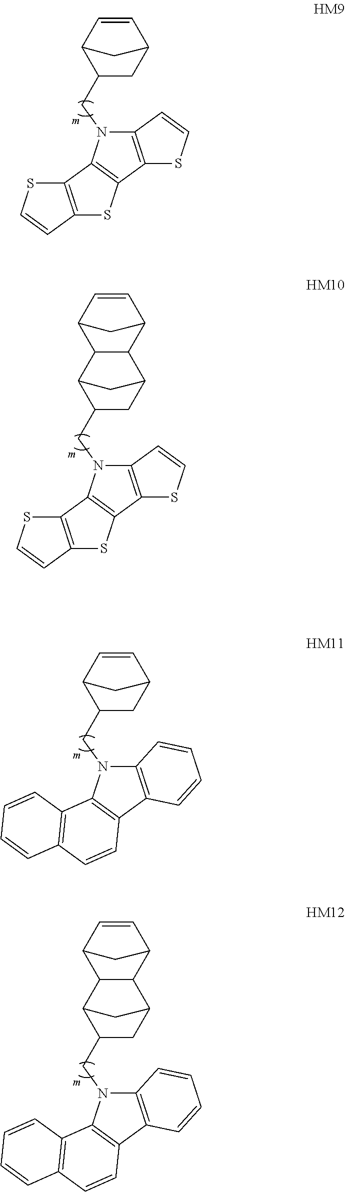 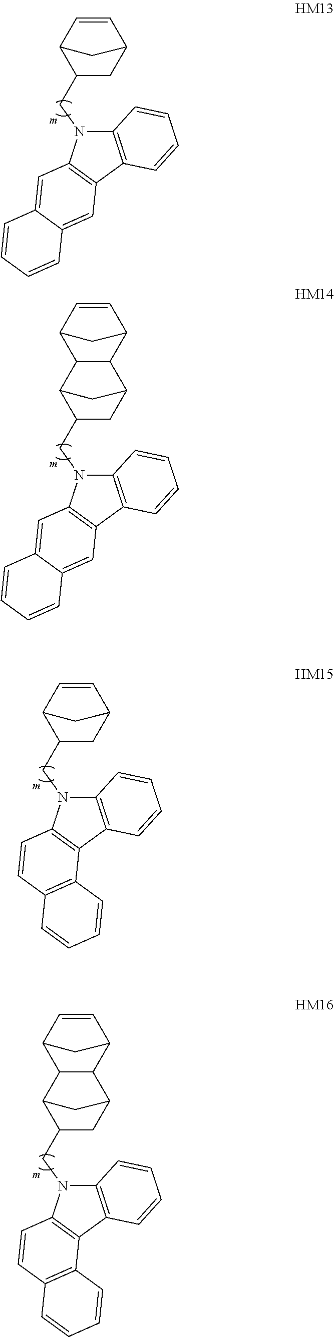 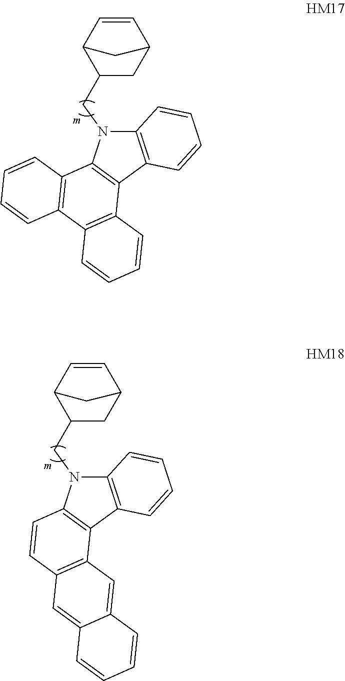
wherein m is a carbon atom number, 0≤m≤10.

4. The preparation method of the cyclic olefin polymer according to claim 2, characterized in that the compound of formula (III) is selected from at least one of M1-M10:

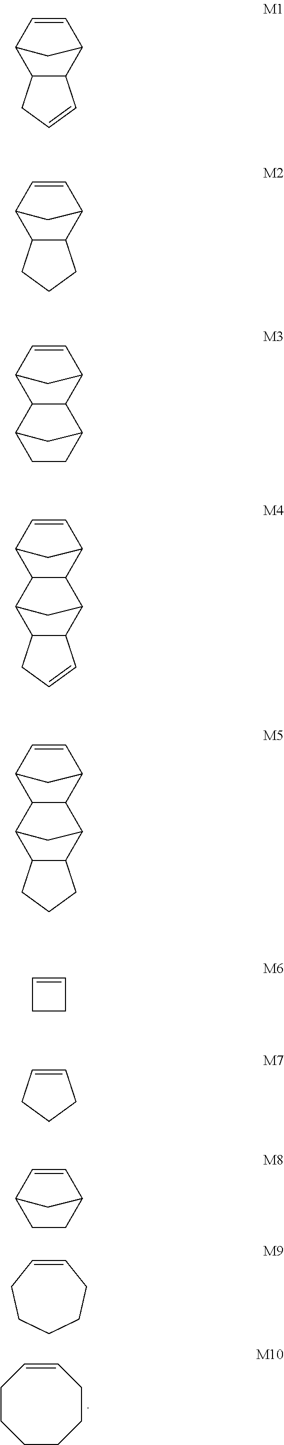

5. The preparation method of the cyclic olefin polymer according to claim 2, characterized in that the catalyst is a ruthenium catalyst, a molybdenum catalyst, or a tungsten catalyst.

6. The preparation method of the cyclic olefin polymer according to claim 2, characterized in that the molar ratio of the monomer to the catalyst is (100-1600): 1.

7. The preparation method of the cyclic olefin polymer according to claim 2, characterized in that the temperature of the ring-opening metathesis polymerization reaction is 25-80° C., and the reaction time is 4-240 min.

8. The preparation method of the cyclic olefin polymer according to claim 2, characterized in that the temperature of the hydrogenation reaction is 100-150° C., and the reaction time is 12-24 h.

9. An optical material, characterized in that the raw material comprises the cyclic olefin polymer according to claim 1.
